(19) United States
(12) Patent Application Publication
(10) Pub. No.: US 2018/0299269 A1
(43) Pub. Date: Oct. 18, 2018

(54) MULTI-AXIS, SINGLE-DRIVE INERTIAL DEVICE

(71) Applicant: Lumedyne Technologies Incorporated, San Diego, CA (US)

(72) Inventors: Ozan Anac, Oakland, CA (US); Xiaojun Huang, San Diego, CA (US)

(21) Appl. No.: 15/221,563

(22) Filed: Jul. 27, 2016

(51) Int. Cl. G01C 19/5712; G01P 15/125; G01P 15/03; G01P 15/08; G01C 19/5762

(52) U.S. Cl. CPC G01C 19/5712; G01P 15/125; G01P 15/036; G01P 15/0888; G01P 2015/0862; G01P 15/0802; G01P 2015/0837; G01P 2015/0857; G01C 19/5762

(57) ABSTRACT

Systems and methods are disclosed herein for multi-axis single-drive inertial devices. A multi-axis single drive inertial device can include a rotational drive configured to oscillate a plurality of accelerometer proof masses and a plurality of gyroscope proof masses about a z axis and signal processing circuitry configured for determining inertial parameters based on motion of the plurality of accelerometer proof masses and the plurality of gyroscope proof masses. The inertial parameters can include acceleration of the inertial device along an x axis perpendicular to the z axis and along a y axis perpendicular to each of the x and z axes, and rotation of the inertial device about each of the x, y, and z axes.

### FIELD OF THE INVENTION

In general, this disclosure relates to inertial sensors used to sense external perturbations such as acceleration and rotation.

### BACKGROUND

Vibratory gyroscopes can measure rotation rate by sensing the motion of a moving proof mass. A Coriolis component of the motion of the moving proof mass is caused by a Coriolis force. The Coriolis force exists only when the gyroscope experiences an external rotation and is due to the Coriolis effect. The Coriolis force can be defined in vector notation by Equation 1, where i, j, and k represent first, second, and third axes, respectively.

\vec{F}_{C}_{_{ĵ}}=−2m[\vec{Ω}_{\hat{k}}×\vec{v}_{î}] (1)

The Coriolis component is proportional to drive velocity as shown in Equations 2 and 3, where SF represents a constant scale factor that includes the mass of the proof mass as well as other constants related to the governing physics, electronics parameters, and the chosen sensor method employed to convert proof mass displacements to an output signal.

$$\begin{matrix}\vert {S}_{OUT}^{C} \vert ∝ \vert \vec{F} \vert ∝ - 2 m \vert \vec{Ω} \vert \vert \vec{v} \vert & ( 2 ) \\ \vert \vec{Ω} \vert = SF \frac{\vert {S}_{OUT}^{C} \vert}{\vert \vec{v} \vert} & ( 3 )\end{matrix}$$

Thus, by measuring an output signal that corresponds to the proof mass displacement, and by measuring the drive velocity, the input rotation rate can be determined.

### SUMMARY

Accordingly, systems and methods are described herein for a multi-axis, single-drive inertial device. An inertial device can include a rotational drive configured to oscillate a plurality of accelerometer proof masses and a plurality of gyroscope proof masses about a z axis and signal processing circuitry configured for determining inertial parameters based on motion of the plurality of accelerometer proof masses and the plurality of gyroscope proof masses. The inertial parameters can include acceleration of the inertial device along an x axis perpendicular to the z axis and along a y axis perpendicular to each of the x and z axes, and rotation of the inertial device about each of the x, y, and z axes.

In some examples, the inertial device can further include coupling springs and drive springs configured for converting rotational motion from the drive into linear motion of each of the accelerometer proof masses. In some examples, the inertial device can further include coupling springs and drive springs configured for converting rotational motion from the drive into linear motion of each of the plurality of gyroscope proof masses.

In some examples, the inertial device can further include time-domain switched (TDS) structures for determining a drive velocity of one or more of the plurality of gyroscope proof masses. In some examples, the signal processing circuitry can be configured for determining acceleration of the inertial device based on one or more offsets in oscillations of one or more of the plurality of accelerometer proof masses. In some examples, the inertial device can further include TDS structures for determining the one or more offsets.

In some examples, the inertial device can further include a plurality of analog front ends (AFE), each configured for measuring changes in capacitance between one of the plurality of gyroscope proof masses and an electrode adjacent to the respective gyroscope proof mass. In some examples, the inertial device can further include a differential amplifier configured for measuring a difference in output between two of the AFE's, wherein the signal processing circuitry determines rotation of the inertial device based on the difference.

In some examples, the inertial device can further include suspension springs configured for shifting a resonant frequency of one of the plurality of accelerometer proof masses to a lower frequency than a resonant frequency of one of the gyroscope proof masses.

An inertial device can be formed by forming a plurality of accelerometer proof masses and a plurality of gyroscope proof masses, forming a rotational drive configured to oscillate the plurality of accelerometer proof masses and the plurality of gyroscope proof masses about a z axis, and forming coupling springs and drive springs configured for converting rotational motion from the drive into linear motion of one or more of the plurality of accelerometer proof masses.

In some examples, forming the inertial device can include forming time-domain switched (TDS) structures configured for determining a drive velocity of one or more of the plurality of gyroscope proof masses. In some examples, forming the inertial device can also include forming TDS structures for determining an acceleration of one or more of the plurality of accelerometer proof masses.

In some examples, forming the inertial device can include forming an electrode adjacent to one or more of the gyroscope proof masses.

In some examples, forming the inertial device can include forming suspension springs configured for shifting a resonant frequency of one of the plurality of accelerometer proof masses to a lower frequency than a resonant frequency of one of the plurality of gyroscope proof masses.

A method of inertial sensing using an inertial device can include oscillating, with a rotational drive, a plurality of accelerometer proof masses and a plurality of gyroscope proof masses about a z axis. The method can also include determining, based on motion of one or more of the plurality of accelerometer proof masses, acceleration of the inertial device along an x axis perpendicular to the z axis and along a y axis perpendicular to each of the x and z axes. The method can also include determining, based on motion of one or more of the plurality of gyroscope proof masses, rotation of the inertial device about each of the x, y, and z axes.

In some examples, the method of inertial sensing can also include determining, using time-domain switched (TDS) structures, a drive velocity of one or more of the plurality of gyroscope proof masses. In some examples, the method of inertial sensing can also include determining acceleration of the inertial device based on one or more offsets in oscillations of one or more of the plurality of accelerometer proof masses. In some examples, the method of inertial sensing can also include determining, using TDS structures, the one or more offsets.

In some examples, the method of inertial sensing can also include measuring, using a plurality of analog front ends (AFE), changes in capacitance between one of the plurality of gyroscope proof masses and an electrode adjacent to the one of the plurality of gyroscope proof masses. In some examples, the method of inertial sensing can also include measuring, using a differential amplifier, a difference in output between two of the AFE's, wherein determining rotation of the inertial device comprises determining based on the difference.

### BRIEF DESCRIPTION OF THE DRAWINGS

FIG. 1 depicts a multi-axis single-drive inertial device that combines a three-axis gyroscope and a two-axis accelerometer into a single monolithic system driven by a single rotational drive, according to an illustrative implementation;

FIG. 2 depicts a gyroscope subassembly of an inertial device, according to an illustrative implementation;

FIG. 3 depicts an accelerometer subassembly that includes a time-domain switched (TDS) structure configured to characterize motion of the accelerometer subassembly in the x direction, according to an illustrative implementation;

FIG. 4 depicts a multi-axis single-drive inertial device that contains subassemblies, according to an illustrative implementation;

FIG. 5 depicts a multi-axis single-drive inertial device configured for measuring acceleration along the x and y axes and rotation about the x, y, and z axes, according to an illustrative implementation;

FIG. 6 depicts a multi-axis single-drive inertial device with gyroscope subassemblies located radially outward from accelerometer subassemblies, according to an illustrative implementation;

FIG. 7 depicts a multi-axis single-drive inertial device that uses single-ended measurement, according to an illustrative implementation;

FIG. 8 depicts a multi-axis single-drive inertial device with gyroscope and TDS subassemblies, according to an illustrative implementation;

FIG. 9 depicts a multi-axis single-drive inertial device with four gyroscope subassemblies and four TDS subassemblies, according to an illustrative implementation;

FIG. 10 depicts three views, each showing a schematic representation of parts of a movable element and a fixed element, according to an illustrative implementation;

FIG. 11 schematically depicts an exemplary process used to extract inertial information from an inertial sensor with periodic geometry, according to an illustrative implementation;

FIG. 12 depicts a graph which represents the association of analog signals derived from an inertial sensor with zero-crossing times and displacements of the inertial sensor, according to an illustrative implementation;

FIG. 13 depicts a graph showing the effects of an external perturbation on input and output signals of the inertial sensors described herein, according to an illustrative implementation;

FIG. 14 depicts a graph that illustrates a response in the form of an electrical current to an oscillator displacement, according to an illustrative implementation;

FIG. 15 depicts a graph showing a rectangular waveform and signal representing zero-crossing times of the current signal depicted in FIG. 14, according to an illustrative implementation;

FIG. 16 is a graph which illustrates additional time intervals of the displacement curve depicted in FIG. 14, according to an illustrative implementation;

FIG. 17 is a graph that depicts the relationship between capacitance of the inertial sensor depicted in FIG. 11 and displacement of the movable element depicted in FIG. 1, according to an illustrative implementation;

FIG. 18 is a graph that depicts the relationship between displacement and the first derivative of capacitance with respect to displacement, according to an illustrative implementation;

FIG. 19 is a graph that depicts the relationship between displacement and the second derivative of capacitance with respect to displacement, according to an illustrative implementation;

FIG. 20 is a graph that depicts the relationship between time, the rate of change of capacitive current, and displacement, according to an illustrative implementation;

FIG. 21 depicts a flow chart of a method used to extract inertial parameters from a nonlinear periodic signal, according to an illustrative implementation;

FIG. 22 depicts a method for determining times of transition between two values based on nonlinear periodic signals, according to an illustrative implementation;

FIG. 23 depicts a method to compute inertial parameters from time intervals, according to an illustrative implementation; and

FIG. 24 depicts a gyroscope subassembly, some or all of the features of which can be included in any of the inertial devices depicted in FIGS. 1-9, according to an illustrative implementation.

### DETAILED DESCRIPTION

Some types of sensors, such as vibratory accelerometers and Coriolis force vibrating gyroscopes, require a proof mass to be oscillated along an axis. Inertial parameters such as accelerations and rotations can affect the oscillating proof mass. In some examples, such as vibratory accelerometers, the oscillations become offset from the neutral point due to an acceleration. To sense inertial parameters acting along multiple axes, an inertial sensing apparatus requires proof masses that oscillate along multiple axes. The systems and methods described herein integrate multiple sensors with proof masses oscillating along different axes into a single multi-axis device driven by a single rotational drive. This allows the motion of each of the proof masses to be synchronized in frequency, phase, and amplitude.

The systems and methods described herein accomplish this integration by converting rotational motion to linear motion, allowing inertial sensors requiring linear proof mass motion to be driven by a rotational drive. Some accelerometers do not require oscillation, while Coriolis gyroscopes do require oscillation. Thus, drift in the drive of the Coriolis gyroscope will cause the gyroscope output to diverge from the accelerometer output, for systems using accelerometers that do not require oscillation. The systems and methods described herein include accelerometers with oscillating proof masses, so the same rotational drive can thus oscillate both proof masses of gyroscope sensors as well as proof masses of accelerometer sensors. The frequency and phase of the inertial sensors are synchronized because the same drive system actuates each of the inertial sensors.

Another benefit of driving multiple sensors with a single rotational drive is that drift in the drive system will affect each of the individual sensors equally, reducing the tendency for the sensor outputs to drift apart over time. For example, a drift in the drive voltage can cause the amplitude of the rotational drive to drift, but because all sensors are driven by the same rotational drive, the amplitudes of all of the sensors will drift in unison. Furthermore, when multiple sensors are driven with the same rotational drive, the sensors can be driven by the same drive circuitry, saving chip area and power.

By including sensors placed at appropriate azimuthal positions on the rotational drive, the inertial device can include sensors moving in orthogonally linear directions. The displacement amplitude of each of the inertial sensors is determined by the angular displacement of the rotational drive and the respective sensor's distance from the pivot point of the rotational drive. Because all of the inertial sensors are driven by the same rotational drive, any drifting in the drive electronics will affect the frequency, phase, and amplitudes of the inertial sensors in the same manner. Likewise, drift due to other factors such as temperature, mechanical stress, or external forces will also affect all the inertial sensors in the same manner. Because the inertial sensors are located relatively close to each other on the same drive frame, mechanical stresses such as packaging stress which deform the overall package of the inertial sensor, will tend to cause minimal relative motion between various parts of the inertial sensor. Thus, the ratio of the drive amplitude of one inertial sensor to the drive amplitude of another inertial sensor is determined by the geometry of the inertial device as fabricated and is not changed by any other factors. This results in an inertial device with sensors that have very stable amplitude ratios, and essentially the same frequency and phase. Thus, the inertial sensors of the inertial device are mechanically synchronized in frequency, phase, and amplitude ratio.

The power consumed by drive electronics is often the largest fraction of total power consumed by an oscillating inertial device. This energy required to power the drive electronics is often significantly more than the kinetic energy required to oscillate the resonators. One reason for this is that leakage in the drive electronics consumes significant amounts of power. Thus, driving multiple inertial sensors with a single oscillating drive reduces the overall power consumption by reducing the number of systems of drive electronics. Furthermore, oscillating inertial sensors often do not oscillate continuously, but only oscillate when their output is required. This may occur when, for example, a user begins using a navigation or virtual reality application of a mobile device that requires inertial sensing. Thus, oscillating resonators are required to start and stop frequently. Starting an oscillating resonator requires adjusting a drive voltage of the resonator in a closed-loop fashion until the amplitude of the oscillations increases to a desired setpoint. Startup times of oscillating inertial devices can range from 10 milliseconds to multiple seconds, depending on the quality factor of the resonators and on other factors. When multiple sensors are driven by a single rotational drive, they can be started and stopped in unison.

Springs in the inertial devices can have certain configurations. In some examples, springs can have tailored stiffness and compliance due to the geometry of the springs. In some examples, the springs comprise a uniform isotropic material. In other examples, the material properties are tailored in various portions of the spring to achieve desired variations in stiffness and compliance.

Designing the inertial device to locate the inertial sensors further from the center of rotation results in higher oscillation amplitudes and more displacement of the proof mass of the inertial sensor. This increases the signal-to-noise ratio of the inertial device. However, locating the inertial sensors further from the pivot point results in more nonlinearity in the motion due to the rotation. The drive and coupling spring systems shown herein can substantially linearize the motion of the proof mass of the inertial sensors. In some examples, the remaining rotational component of the motion of the proof mass is 100 ppm of the linear component. In some examples, the rotational component is as low as 10 ppm of the linear component. Thus, for a proof mass on a vertically-oriented arm and rotating about the origin and having an oscillation in the x direction of 1 micron, the proof mass only moves in the y direction by 0.1 nanometers (corresponding to 100 ppm) or as little as 0.01 nanometers (corresponding to 10 ppm).

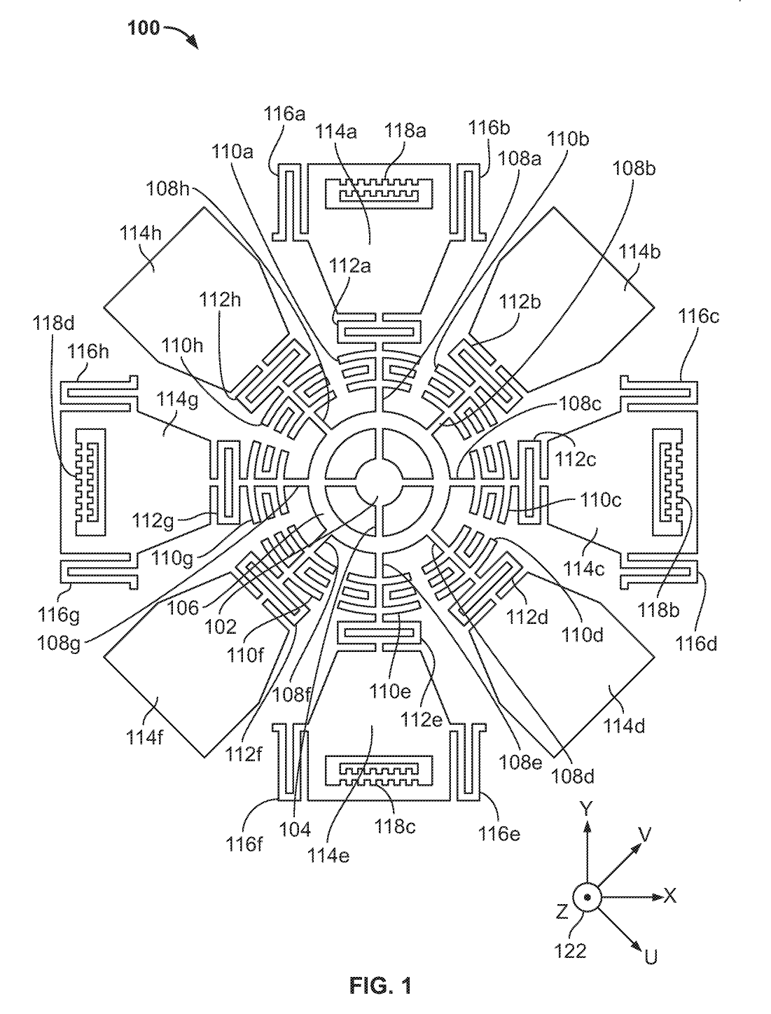

FIG. 1 depicts a multi-axis inertial device 100 that combines a three-axis gyroscope and a two-axis accelerometer into a single monolithic system driven by a single rotational drive. The inertial device 100 includes four accelerometer subassemblies 114a, 114c, 114e, and 114g, and four gyroscope subassemblies 114b, 114d, 114f, and 114h. The inertial device 100 includes a central anchor 102 that is anchored to a bottom layer (not shown) and/or a cap layer (not shown) of the inertial device. The bottom layer and/or the cap layer may be a separate wafer bonded to the device layer (shown) at anchors of the device layer. In some examples, the bottom layer and cap layer are made from different wafers than the device layer. In some examples, one or more features of the device layer can be made from the wafers containing the bottom layer and/or the cap layer. The region between the bottom and cap layers can be at a pressure below atmospheric pressure. In some examples, a gettering material such as titanium or aluminum is deposited to maintain the reduced pressure for an extended period of time after manufacturing the inertial device 100.

FIG. 1 also depicts a coordinate system 122 with an x-y-z coordinate system sharing a z axis and an origin with a u-v-z coordinate system. While the coordinate system 122 is depicted offset from the inertial device 100 for clarity, the origin of the coordinate system 122 is located at the center of the central anchor 102. The x and y axes are orthogonal to each other. The u and v axes are orthogonal to each other and are rotated by −45 degrees from the x and y axes, respectively.

The inertial device 100 also includes a rotational spring 104. The rotational spring 104 is schematically depicted in FIG. 1 and allows a drive frame 106 to rotate relative to the central anchor 102. The drive frame 106 transmits the rotation from the rotational spring to drive arms 108a, 108b, 108c, 108d, 108e, 108f, 108g, and 108h (collectively, drive arms 108). The drive arms 108 in turn transmit the rotation to the inertial subassemblies 114a, 114b, 114c, 114d, 114e, 114f, 114g, and 114h (collectively inertial subassemblies 114). The inertial device 100 also includes comb drives 110a, 110b, 110c, 110d, 110e, 110f, 110g, and 110h (collectively, comb drives 110), schematically depicted in FIG. 1. The comb drives 110 contain fixed combs anchored to the bottom layer and/or the cap layer and drive combs connected to respective drive arms of the drive arms 108. When a voltage is applied between the fixed and movable combs of the comb drives 110, the comb drives 110 cause the arms 108 to rotate relative to the central anchor 102.

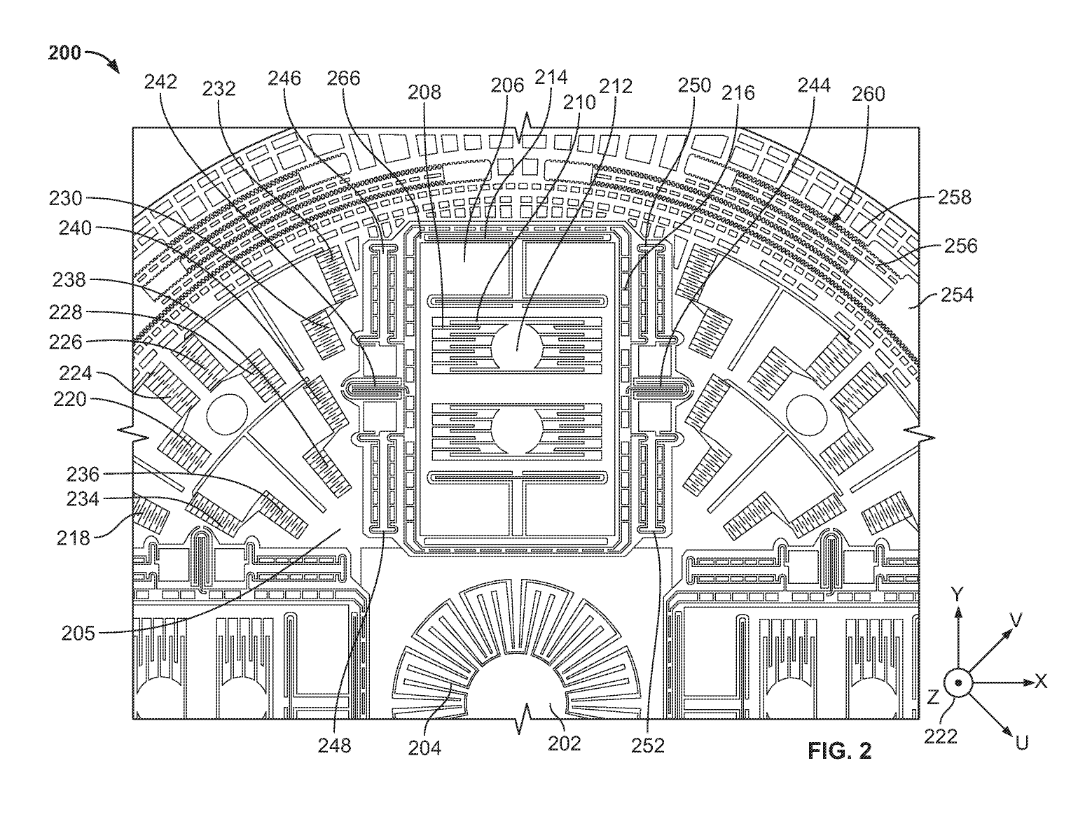

The drive frame 106 and the arms 108 are stiff and effectively transfer rotational motion. The inertial device 100 includes coupling springs 112a, 112b, 112c, 112d, 112e, 112f, 112g, and 112h (collectively, coupling springs 112). Each of the coupling springs 112 is connected to a respective arm 108 and transfers the rotational motion imparted by the arm 108 to the respective subassembly 114. The coupling springs 112 are stiff in the circumferential direction but flexible in the radial direction. The inertial device 100 also includes drive springs 116a, 116b, 116c, 116d, 116e, 116f, 116g, and 116h (collectively, drive springs 116). The drive springs 116 are stiff in the radial direction but flexible along an axis perpendicular to an axis lying along the center of each of the respective arms 108a, 108c, 108e, and 108g when the arms are in their neutral positions. The drive springs 116, working in concert with the coupling springs 112, convert rotational motion of the arms 108 to linear motion of the accelerometer subassemblies 114a, 114c, 114e, and 114g. Operation of drive springs such as the drive springs 116 and coupling springs such as the coupling springs 112 are described in more detail with reference to FIG. 2. In some examples, the gyroscope subassemblies 114b, 114d, 114f, and 114h can also be supported by drive springs (not shown).

An AC voltage is applied to the comb drives 110 to cause the arms 108 and the drive frame 106 to rotationally oscillate about the central anchor 102. Because the drive springs 116 and the coupling springs 112 convert the rotational motion of the arms 108 into linear motion of the accelerometer subassemblies 114a, 114c, 114e, and 114g, the accelerometer subassemblies 114a, 114c, 114e, and 114g oscillate linearly. The accelerometer subassemblies 114a and 114e oscillate along the x axis, while the accelerometer subassemblies 114c and 114g oscillate along the y axis.

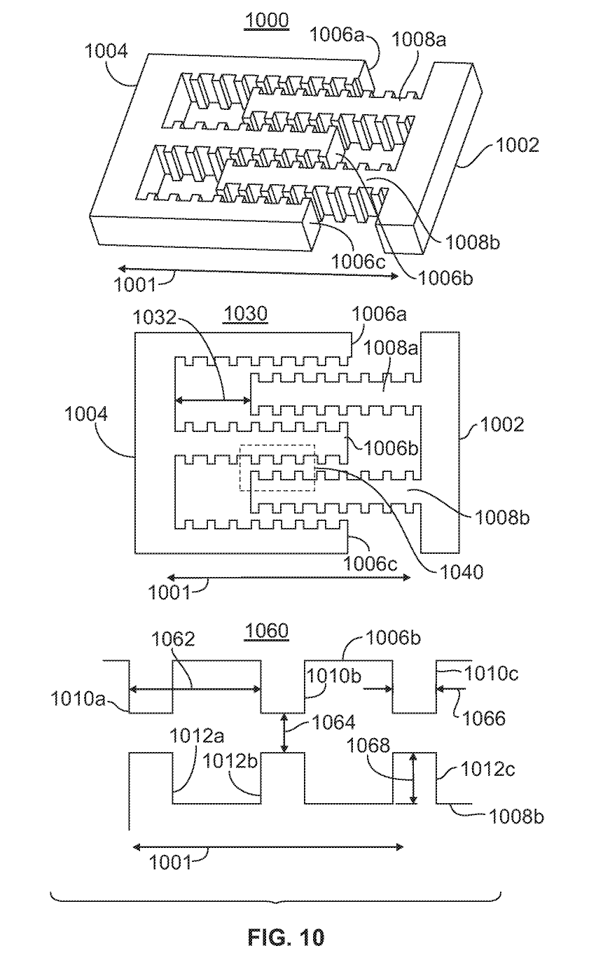

The inertial device 100 includes time-domain-switched (TDS) structures 118a, 118b, 118c, and 118d (collectively, TDS structures 118). The TDS structures 118 are configured to produce an output indicating motion of the accelerometer subassemblies 114a, 114c, 114e and 114g. In some examples, the output of the TDS structures 118 can be used to determine an offset in the oscillation of the accelerometer subassemblies 114a, 114c, 114e, and 114g. The TDS structures 118 depicted in FIG. 1 are schematic representations and can include more teeth than depicted in FIG. 1 and can also include multiple rows of teeth on respective beams to provide an improved signal-to-noise ratio. The TDS structures 118 are described in more detail with reference to FIGS. 10-23.

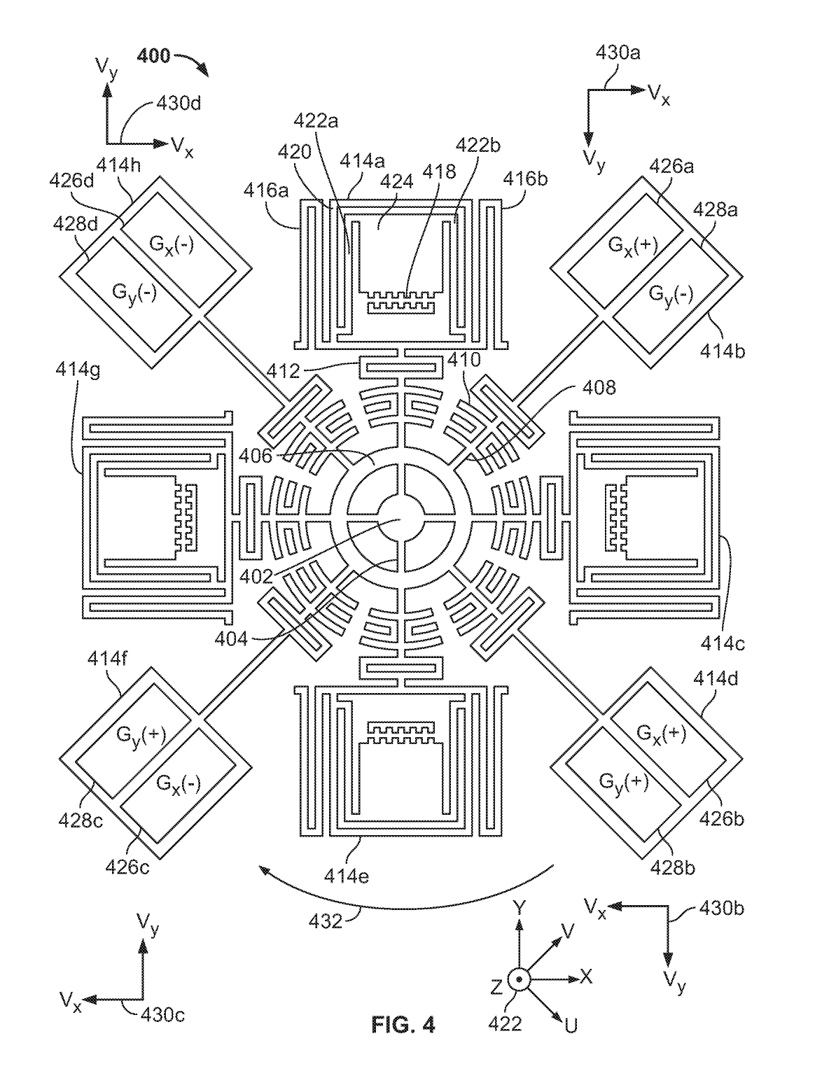

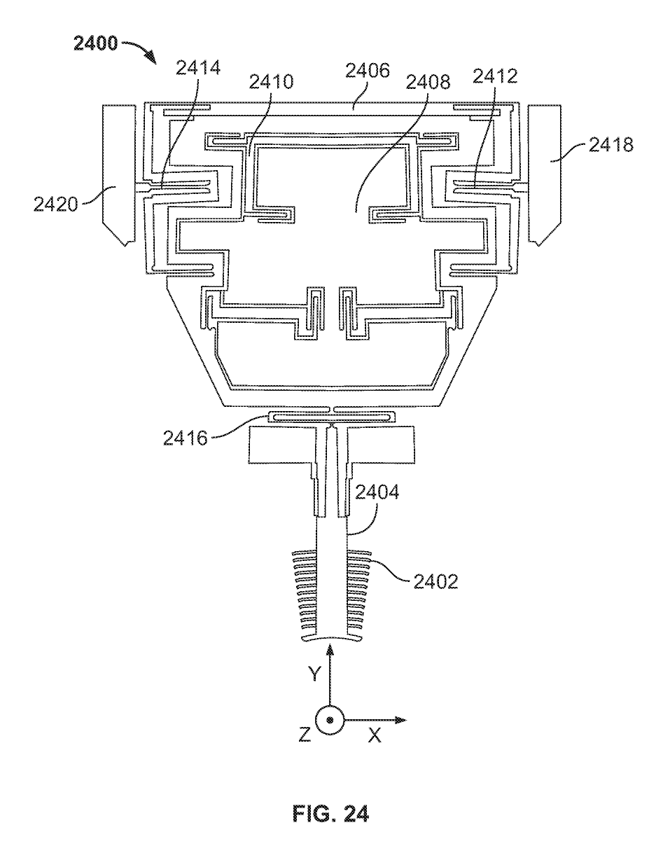

The inertial device 100 also includes gyroscope subassemblies 114b, 114d, 114f, and 114h. The gyroscope subassemblies 114b and 114f contain proof masses that deflect in the v direction (which has x and y components) in response to a Coriolis force caused by a rotation of the inertial device 100 about the z axis, and in the z direction in response to a Coriolis force caused by a rotation of the inertial device 100 about either or both of the x and y axes. The gyroscope subassemblies 114d and 114h contain proof masses that deflect in the u direction (which has x and y components) in response to a Coriolis force caused by a rotation of the inertial device 100 about the z axis, and deflect in the z direction in response to a Coriolis force caused by a rotation of the inertial device 100 about either or both of the x and y axes. Deflection of the proof masses of the gyroscope subassemblies 114b, 114d, 114f, and 114h can be measured by measuring a change in capacitance between the respective proof masses and respective gyroscope electrodes (not shown). The gyroscope subassemblies 114b, 114d, 114f, and 114h can include some or all of the features of the gyroscope subassemblies 266 (FIG. 2); the gyroscope subassemblies 414b, 414d, 414f, and 414h (FIG. 4); and the gyroscope subassembly 2400 (FIG. 24).

A rotational drive is capable of providing motion along two orthogonal axes with a single drive mechanism. Drive springs and coupling springs can convert rotational motion of the drive mechanism to linear motion of inertial subassemblies as described herein. Linear motion of inertial subassemblies can be beneficial, because some types of subassemblies such as accelerometer and gyroscope subassemblies can be designed to measure inertial parameters based on linear motion of one or more proof masses. The single rotational drive can cause orthogonal motion of separate inertial subassemblies. This can be achieved by simply placing inertial subassemblies 90° apart from each other on the rotational drive. Thus, when the drive frame of the inertial device is rotationally oscillated, the respective subassemblies will oscillate linearly in orthogonal directions.

By converting rotational motion to linear motion, multiple inertial subassemblies can be combined into a single monolithic device and driven by a single rotational drive. Driving multiple inertial subassemblies by the same rotational drive enables specific ratios of oscillation amplitudes to be implemented with precision. Some inertial subassemblies require high amplitudes, and some may require amplitudes that are lower. The amplitudes of each subassembly can be determined by appropriate selection of the arm distance, or the distance of the respective subassembly from the center of rotation. Once the inertial device is fabricated, the ratios of amplitudes between inertial subassemblies will remain constant. Any external perturbations such as thermal expansion, packaging stress, electrical noise, or zero drift of electronic components will affect all of the subassemblies in the same manner, because they are all driven by a single drive.

Integrating multiple inertial subassemblies into a single monolithic device driven by a single drive also has the benefit of space efficiency. Chip size is limited and expensive, and combining multiple inertial subassemblies into a single drive can result in an overall decrease in chip area. Less space is required for the drive system, because a single drive system drives multiple subassemblies. Less space is also required for the suspension system, because a single rotational spring can, in some examples, support all of the inertial subassemblies.

FIG. 2 depicts a gyroscope subassembly 266 of an inertial device 200. The gyroscope subassembly 266 is connected to a drive frame 205 by coupling springs 242 and 244 and by drive springs 246, 248, 250, and 252. The inertial device 200 includes a central anchor 202 and a rotational spring 204. The drive frame 205 is connected to the central anchor 202 by the rotational spring 204. The inertial device 200 also includes thirty-two drive combs, seven of which are labeled in FIG. 2 as drive combs 218, 220, 224, 226, 228, 230, and 232. The inertial device 200 includes twelve drive sense combs, four of which are labeled in FIG. 2 as drive sense combs 234, 236, 238, and 240. FIG. 2 also depicts a coordinate system 222 with an x-y-z coordinate system sharing a z axis and an origin with a u-v-z coordinate system. While the coordinate system 222 is depicted offset from the inertial device 200 for clarity, the origin of the coordinate system 222 is located at the center of the central anchor 202. The x and y axes are orthogonal to each other. The u and v axes are orthogonal to each other and are rotated by −45 degrees from the x and y axes, respectively.

An AC voltage is applied to the drive combs (e.g., 218, 220, 224, 226, 228, 230, and 232), which causes the drive frame 205 to rotationally oscillate about the z axis. The drive sense combs (e.g., 234, 236, 238, and 240) provide output signals that can be used for closed-loop control of the drive combs (e.g., 218, 220, 224, 226, 228, 230, and 232), measurement of the velocity of the drive frame 205, or both. In some examples, some of the drive sense combs (e.g., 234, 236, 238, and 240) are used for closed-loop control and some are used for measuring the velocity of the drive frame 205.

The coupling springs 242 and 244 of the inertial device 200 are located circumferentially adjacent to the gyroscope subassembly 266. The coupling springs 242 and 244 are rigid in the x direction but are compliant in the y direction. Thus, the coupling springs 242 and 244 transfer motion in the x direction from the drive frame 205 to the gyroscope subassembly 266 while allowing relative motion between the drive frame 205 and the gyroscope subassembly 266 in the y direction. The drive springs 246, 248, 250, and 252 are rigid in the y direction but are compliant in the x direction. Thus, the drive springs 246, 248, 250, and 252 allow the gyroscope subassembly 266 to move in the x direction but prevent it from moving in the y direction and thereby reduce quadrature. Accordingly, the combination of the coupling springs 242 and 244 and the drive springs 246, 248, 250, and 252, with appropriately tailored geometry, stiffness and compliance, convert rotational motion of the drive frame 205 about the z axis into linear motion of the gyroscope subassembly 266 along the x axis. This spring combination allows a rotational drive to oscillate an inertial sensor in a linear direction with reduced error due to nonlinearity.

FIG. 2 also depicts a spring system 214 that connects the proof mass 206 to a drive frame 216. The drive frame 216 is in turn connected to the coupling springs 242 and 244 and the drive springs 246, 248, 250, and 252. The drive frame 216 transfers motion imparted by the coupling springs and the drive springs to the proof mass 206 via the spring system 214. The spring system 214 allows the proof mass 206 to move relative to the drive frame 216 in they and z directions. Thus, the proof mass 206 can respond to Coriolis forces caused by rotation of the inertial device about the y and z axes. When the inertial device is rotated about the y axis while the drive frame 205 oscillates about the z axis, a Coriolis force causes the proof mass 206 to move in the z direction. When the inertial device is rotated about the z axis, a Coriolis force causes the proof mass 206 to move in the y direction.

FIG. 2 also depicts movable combs 208 and fixed combs 210. The movable combs 208 are connected to the proof mass 206 and move with it. The fixed combs 210 are connected to an anchor 212 that is fixed to the bottom layer of the inertial device 200. The anchor 212 can alternatively be fixed to the top layer of the inertial device 200, or to both the top and bottom layers of the inertial device 200. The anchor 212 and the fixed combs 210 do not move when the drive frame 205 is rotated. As the proof mass 206 moves along the y axis in response to a Coriolis force, the gaps between adjacent combs of the movable combs 208 and the fixed combs 210 change in size. A sense voltage is applied between the movable combs 208 and the fixed combs 210. Because the drive frame 216 and the proof mass 206 are oscillating in the x direction, the gaps will change at the same frequency as the oscillation frequency. This changing gap causes a time-varying capacitance, which causes an AC capacitive current to flow between the movable combs 208 and the fixed combs 210. This AC capacitive current can be detected with a transimpedance amplifier. Alternatively, or in conjunction, the time-varying capacitance can be detected with a charge amplifier or a bridge circuit. By measuring the time-varying capacitance or capacitive current, signal processing circuitry can measure motion of the proof mass 206 in response to a Coriolis force.

The inertial device 200 includes gyroscope electrodes (not shown) similar to gyroscope electrodes 426 and 428 (FIG. 4) for measuring displacement of the proof mass 206 in the z direction caused by a Coriolis force. This Coriolis force is caused by a rotation of the inertial device about the y axis while the drive frame 216 is oscillating in the x direction. By measuring displacement of the proof mass 206 in the z direction, the Coriolis force and thus the rotation can be determined.

The inertial device 200 also includes a TDS structure 260. The TDS structure 260 includes movable teeth 258, fixed teeth 256, and an anchor 254. The anchor 254 is anchored to the bottom layer and/or the cap layer and does not move relative to the central anchor 202. Thus, the fixed teeth 256 also do not move relative to the central anchor 202. The movable teeth 258 are connected to the drive frame 205 and rotate with it. As the movable teeth 258 rotate about the z axis, the capacitance between the fixed teeth 256 and the movable teeth 258 varies nonlinearly. The velocity of the drive frame 205 can be determined based on the nonlinearly varying capacitance using the systems and methods described with reference to FIGS. 10-23. The velocity of the drive frame 205 is then used for one or more purposes including for maintaining the same velocity in the face of changing environmental conditions such as temperature and pressure, and for determining rates of rotation acting upon the inertial device 200.

In some examples, the inertial device 200 does not contain any TDS structures (e.g. 260) and instead uses the drive sense combs (e.g., 234, 236, 238, and 240) for both velocity measurement and drive comb regulation. In some examples, the inertial device 200 does not include drive sense combs (e.g., 234, 236, 238, and 240) and uses TDS structures (e.g., 260) for both velocity measurement and drive comb regulation. In some examples, the inertial device 200 contains both TDS structures (e.g., 260) and drive sense combs (e.g., 234, 236, 238, and 240) and uses the TDS structures (e.g., 260) for drive comb regulation and the drive sense combs (e.g., 234, 236, 238, and 240) for velocity measurement. In some examples, the inertial device 200 uses the TDS structures (e.g., 260) for velocity measurement and the drive sense combs (e.g., 234, 236, 238, and 240) for drive comb regulation.

In some examples, the inertial device 200 does not have a central anchor 202. In these examples, the drive frame 205 is anchored to the bottom layer and/or the cap layer at an outer location. Some or all of the features of the gyroscope subassembly 266 can be included in any of the gyroscope subassemblies depicted in FIGS. 1 and 3-9. In any of these implementations, the drive frame 205 can be driven by a rotational drive different than the rotational drive depicted in FIG. 2. In some implementations, the drive frame 205 can be driven by an arm connected to the rotational spring 204. In some examples, the coupling springs 242 and 244 are connected directly to an arm that is connected to the rotational spring 204.

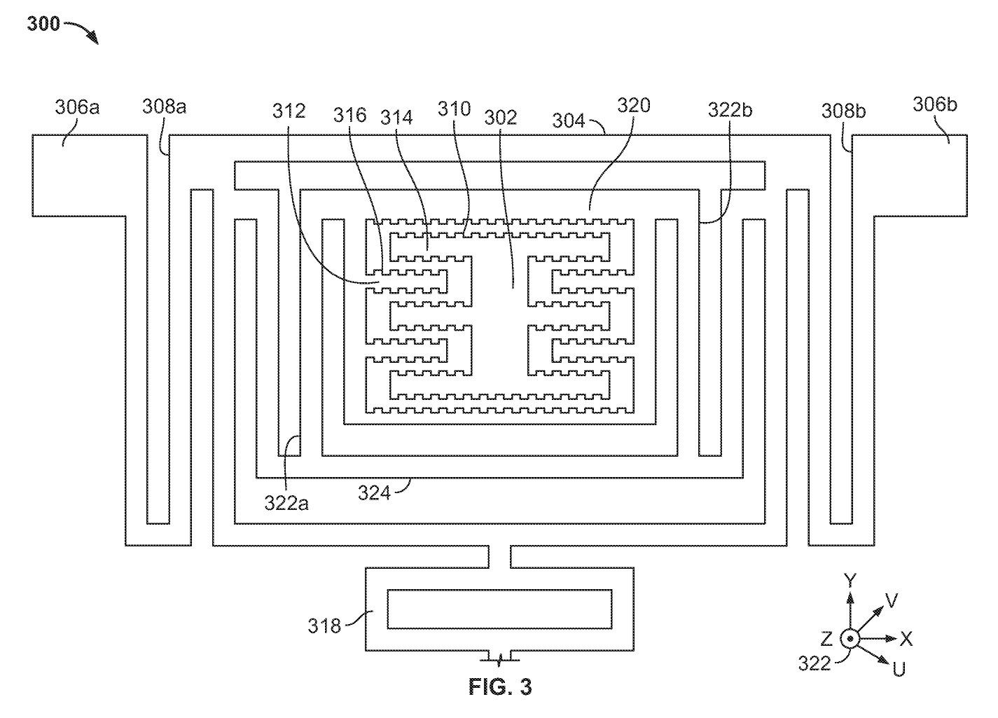

FIG. 3 depicts an accelerometer subassembly 300 that includes a TDS structure 301 configured to characterize motion of the accelerometer subassembly 300 in the x direction. The accelerometer subassembly also includes a drive frame 304, drive springs 308a and 308b (collectively, drive springs 308), outer anchors 306a and 306b (collectively outer anchors 306), and a coupling spring 318.

FIG. 3 also depicts a coordinate system 322 with an x-y-z coordinate system sharing a z axis and an origin with a u-v-z coordinate system. While the coordinate system 322 is depicted offset from the accelerometer subassembly 300 for clarity, the origin of the coordinate system 322 is located on an axis (not shown) about which the accelerometer subassembly 300 rotates. The x and y axes are orthogonal to each other. The u and v axes are orthogonal to each other and are rotated by −45 degrees from the x and y axes, respectively.

The coupling spring 318 is rigid in the x direction but is compliant in the y direction. Thus, the coupling spring 318 transfers motion in the x direction from a central drive frame (not shown) to the gyroscope subassembly 300 while allowing relative motion between the central drive frame (not shown) and the gyroscope subassembly 300 in the y direction. The drive springs 308 are rigid in the y direction but are compliant in the x direction. Thus, the drive springs 308 allow the gyroscope subassembly 300 to move in the x direction but prevent it from moving in the y direction. Accordingly, the combination of the coupling spring 318 and the drive springs 308, with appropriately tailored geometry, stiffness and compliance, convert rotational motion of the central drive frame (not shown) about the z axis into linear motion of the gyroscope subassembly 300 along the x axis. This spring combination allows a rotating drive frame to oscillate an inertial sensor in a linear direction with reduced errors due to nonlinear motion.

The TDS structure 301 includes a movable beam 312 comprising a plurality of equally spaced teeth 316. The TDS structure 301 also includes a fixed element 302 comprising a fixed beam 314, itself comprising a plurality of teeth 310. The fixed element 302 is anchored to the bottom layer and/or the cap layer and does not move relative to a central anchor (e.g., 102 (FIG. 1)). The TDS structure 301 can produce nonlinear capacitive signals for determining either velocity in the x direction of the drive frame 304, an offset in oscillations along the x direction of the drive frame 304, or both. The systems and methods described with reference to FIGS. 10-23 can be used to determine this velocity and offset. The offset in the oscillations is proportional to an acceleration acting on the inertial device 100 in the x direction.

One or more features of the accelerometer subassembly 300 can be included in any of the accelerometer subassemblies described herein. The TDS structure 301 can be included as the any of the TDS structures schematically represented in FIGS. 1-9 (e.g., TDS structures 118, 260, 418, 518, 618, 718, 842, 844, 918) and in any of the inertial devices described herein. The TDS structure 300 can have a different number of beams and/or teeth than is depicted in FIG. 3. In some examples, the TDS structure 300 can also have teeth arranged in an arc rather than in a line and in some examples can be used to measure rotational parameters such as drive frame velocity.

FIG. 4 depicts an inertial device 400 that contains subassemblies 414a, 414b, 414c, 414d, 414e, 414f, 414g and 414h (collectively, subassemblies 414). The subassemblies 414a, 414c, 414e, and 414g are accelerometer subassemblies and the subassemblies 414b, 414d, 414f, and 414h are gyroscope subassemblies. The inertial device 400 includes a central anchor 402, a rotational spring 404, a central frame 406, arms 408, and comb drives 410 similar to those described with reference to FIGS. 1-3.

FIG. 4 also depicts a coordinate system 422 with an x-y-z coordinate system sharing a z axis and an origin with a u-v-z coordinate system. While the coordinate system 422 is depicted offset from the inertial device 400 for clarity, the origin of the coordinate system 422 is located at the center of the central anchor 402. The x and y axes are orthogonal to each other. The u and v axes are orthogonal to each other and are rotated by −45 degrees from the x and y axes, respectively.

As shown, the accelerometer subassemblies 414a, 414c, 414e, and 414g are located on shorter arms than the gyroscope subassemblies 414b, 414d, 414f, and 414h. Because the subassemblies 414 are connected to the same central frame 406 and rotate at the same angular velocity, the difference in arm length results in the gyroscope subassemblies 414b, 414d, 414f, and 414h having a higher amplitude of displacement than the accelerometer subassemblies. The ratio of displacement amplitude is proportional to the ratio of arm length. Each of the accelerometer subassemblies 414a, 414c, 414e, and 414g are connected to the drive arms (e.g., 408) by a coupling spring (e.g., 412) and are connected to outer anchors by a pair of drive springs e.g., 416a and 416b. The coupling springs 412 and the drive springs 416a and 416b convert the rotational motion of the comb drive (e.g., 410) into linear motion of the accelerometer subassemblies 414a, 414c, 414e, and 414g. In some examples, the gyroscope subassemblies 414b, 414d, 414f, and 414h can also be supported by drive springs (not shown). The accelerometer subassembly 414a is connected to the arm and comb drive 410 by a coupling spring 412 and is connected to outer anchors by drive springs 416a and 416b. The accelerometer subassembly 414a includes a drive frame 420 that is rigid and transfers motion through suspension springs 422a and 422b (collectively, suspension springs 422) to a proof mass 424. The proof mass 424 includes a TDS structure 418 that is used to measure the velocity of the proof mass 424. The TDS structure 418 includes teeth located on the proof mass 424 and teeth located on a fixed structure anchored to the bottom layer and/or the cap layer of the inertial device 400.

The comb drive 410 oscillates at a single frequency, causing all of the arms supporting each of the inertial subassemblies 414a, 414b, 414c, 414d, 414e, 414f, 414g, and 414h (collectively, inertial subassemblies 414) to oscillate at the same frequency. However, in some examples, oscillating at a single frequency is not optimal for both gyroscopes and accelerometers. This is because a given inertial subassembly will be most sensitive (i.e. experience the highest amplitude response) to input excitations near the resonant frequency of the subassembly. Furthermore, driving a subassembly to oscillate near its resonant frequency will consume lower power than driving it to oscillate at other frequencies.

However, resonant frequencies can be different for different types of inertial sensors. For example, increasing the oscillation frequency of a gyroscope subassembly increases the Coriolis-induced displacement, thus increasing the sensitivity of the gyroscope. However, lower natural frequencies of accelerometers result in higher sensitivity, especially for low-frequency input accelerations. This can thus lead to conflicting requirements, with a high resonant frequency desired for a gyroscope and a low resonant frequency desired for an accelerometer. These two types of sensors can be monolithically integrated using by a single rotational drive to drive both an accelerometer and a gyroscope at or near the resonant frequency of the gyroscope and using suspension springs to shift the resonant frequency of the accelerometer to a lower frequency, one that provides more sensitivity at frequencies of input accelerations.

The accelerometer subassemblies of the inertial device 400 include such suspension springs.

The accelerometer subassembly 414a includes suspension springs 422a and 422 b that cause the proof mass 424 to have a lower resonant frequency than that of an accelerometer subassembly without suspension springs. Thus, the drive frame 420 oscillates at the same frequency as the comb drive 410 and the gyroscope subassemblies 414b, 414d, 414f, and 414h, but the proof mass 424 oscillates at a lower frequency. This occurs even though the proof mass 424 is actuated by the same comb drives 410 as the rest of the inertial device 400. The accelerometer subassemblies 414c, 414e, and 414g have similar suspension springs as the accelerometer subassembly 414a. Thus, the inertial device 400 uses a single rotational drive to oscillate the gyroscope subassemblies 414b, 414d, 414f, and 414h at a high frequency and proof masses of the accelerometer subassemblies 414a, 414c, 414e, and 414g at a lower frequency. In some examples, the gyroscope subassemblies 414b, 414d, 414f, and 414h include suspension springs and the accelerometer subassemblies 414a, 414c, 414e, and 414g do not. In some examples, all of the subassemblies 414 contain suspension springs. Including suspension springs in at least one type of subassembly enables each type of subassembly to have its optimum resonant frequency while still retaining the benefits of a single drive. The suspension springs 422 can be implemented in any of the inertial subassemblies depicted in FIGS. 1-9 to adjust the resonant frequency of a proof mass.

The inertial device 400 also includes gyroscope electrodes 426a, 426b, 426c, and 426d (collectively, gyroscope electrodes 426) and gyroscope electrodes 428a, 428b, 428c, and 428d (collectively, gyroscope electrodes 428). The gyroscope electrodes 426 and the gyroscope electrodes 428 are located in a different layer than the device layer containing the rest of the structures depicted in FIG. 4. In some examples, the gyroscope electrodes 426 and the gyroscope electrodes 428 are located in a cap layer above the device layer, and in some examples in a bottom layer below the device layer. The gyroscope electrodes 426 and the gyroscope electrodes 428 detect deflection of respective proof masses of the gyroscope subassemblies 414b, 414d, 414f, and 414h in the z direction in response to rotations about the x and y axes, respectively.

In an example, the inertial device 400 experiences an input rotation about the x axis and having a vector in the +x direction. The comb drive of the inertial device 400 causes the inertial subassembly 414 to oscillate about the z axis, alternating between clockwise and counterclockwise rotation. In the example and at the instant depicted in FIG. 4, the comb drive 410 is rotating the inertial subassemblies 414 in a clockwise direction as depicted by an arrow 432. In this example, the gyroscope electrodes 426 and 428 are located above (displaced in the +z direction from) the inertial subassemblies 414. In this example, at the instant depicted in FIG. 4, the gyroscope subassembly 414b has a drive velocity with components in the +x and −y directions, indicated by the arrows 430a, and the gyroscope subassembly 414d has a drive velocity with components in the −x and −y directions, indicated by the arrows 430b. At the same instant, the gyroscope subassembly 414f has a drive velocity with components in the −x and +y directions, indicated by the arrows 430c, and the gyroscope subassembly 414h has a drive velocity with components in the +x and +y directions, indicated by the arrows 430d.

The x component of the drive velocity of the gyroscope subassembly 414b will not produce a Coriolis force due to an input rotation about the x axis, but the y component of the drive velocity of the gyroscope subassembly 414b will produce such a Coriolis force. This Coriolis force is proportional to the vector cross product of the input rotation vector and the drive velocity vector. Thus, the Coriolis force will act on the gyroscope subassembly 414b in the +z direction and will cause a proof mass of the gyroscope subassembly 414b to deflect in the +z direction. This will cause the proof mass to move closer to the gyroscope electrodes 426a and 428a. Because the proof mass of the gyroscope subassembly 414b has moved closer to the gyroscope electrodes 426a and 428 a, a capacitance between the proof mass and these electrodes has increased. This capacitance can be measured and used to determine a displacement of the proof mass along the z axis.

In this example, when the inertial subassemblies 414 are rotating clockwise, the gyroscopes subassembly 414d is moving in the −x and −y directions. As with the gyroscopes subassembly 414b, the −y component of the drive velocity, combined with the input rotation having a +x vector, will result in a Coriolis force that causes a proof mass of the gyroscope subassembly 414d to deflect in the +z direction. The motion of the proof mass of the gyroscope subassembly 414d in the +z direction will close the gap between the proof mass and the gyroscope electrodes 426b and 428b, increasing capacitance between the proof mass and the respective electrodes. Because the gyroscope subassemblies 414f and 414h each have a velocity component in the +y direction in this example, proof masses of the gyroscope subassemblies 414f and 414h will deflect in the −z direction due to a Coriolis effect and will move further away from the gyroscope electrodes 426c, 428c, 426d, and 428d, resulting in a decrease in capacitance.

When the inertial device 400 is rotated about the y axis and with a rotation vector in the +y direction, a Coriolis force will cause the proof masses of the gyroscope subassemblies 414b and 414h to deflect in the +z direction, increasing the capacitances between these proof masses and the respective gyroscope electrodes 426a, 428a, 426d, and 428d. Likewise, a Coriolis force will cause the proof masses of the gyroscope subassemblies 414d and 414f to deflect in the −z direction, decreasing the capacitances between these proof masses and the gyroscope electrodes 426b, 428b, 426c, and 428c.

A potential difference exists between each of the proof masses of gyroscope subassemblies 414b, 414d, 414f, and 414h and the adjacent gyroscope electrodes 426 and 428. This potential difference can be created by biasing the proof masses to a different potential than the gyroscope electrodes 426 and 428, or by applying a voltage between the proof masses and the gyroscope electrodes. In some examples, a +1 V bias is applied to each of the gyroscope electrodes 426 and 428, and a +10 V bias is applied to each of the proof masses of gyroscope subassemblies 414b, 414d, 414f, and 414h. This results in a 9 V potential difference between the proof masses and the adjacent gyroscope electrodes (e.g. 426 and 428). Although the potential difference is constant, the proof masses are constantly oscillating. This constant oscillation means that the instantaneous drive velocity of a given proof mass is also constantly changing. As part of the oscillation, the proof mass accelerates in a first direction to a maximum drive velocity, decelerates to an instantaneous halt, then accelerates in a second direction opposite to the first direction. Because the instantaneous Coriolis force is proportional to the instantaneous drive velocity, the Coriolis force varies with the drive velocity, even if the input rotation rate remains constant. Thus, the gap and the capacitance will also vary with the drive velocity, and at the frequency of the drive velocity.

The gyroscope electrodes 426 are configured to differentially measure displacement of the proof masses of the gyroscope subassembly 414 in response to input rotations about the x axis, and the gyroscope electrodes 428 are configured to measure deflection of the proof masses in response to input rotations about the y axis. The gyroscope electrodes 426a and 426b are electrically connected to a first analog front end (AFE), an output of which is connected to a first terminal of a first differential amplifier. The gyroscope electrodes 426c and 426d are electrically connected to a second AFE, an output of which is connected to a second terminal of the first differential amplifier. Each of the AFE's outputs a signal proportional to the average capacitance or average time rate of change of capacitance of the two electrodes connected to it. The AFE's may be transimpedance amplifiers, charge amplifiers, or bridge circuits. The first differential amplifier then produces an output proportional to the difference in the outputs of the first and second AFE's. This difference is proportional to the Coriolis force induced by a rotation of the inertial device 400 about the x axis. Likewise, the gyroscope electrodes 428a and 428d are electrically connected to a third AFE, an output of which is connected to a first terminal of a second differential amplifier. The gyroscope electrodes 428b and 428c are electrically connected to a fourth AFE, an output of which is connected to a second terminal of the second differential amplifier. The second differential amplifier then produces an output proportional to the difference in the outputs of the third and fourth AFE's. This difference is proportional to the Coriolis force induced by a rotation of the inertial device 400 about the y axis.

The outputs of the first and second differential amplifiers are proportional to the Coriolis forces caused by rotation of the inertial device 400 about the x and y axes, respectively. Measuring the outputs of the AFE's differentially eliminates the influence of many sources of common-mode noise, including temperature, differential thermal expansion, and bias drift. This is because common-mode noise will affect both electrodes in the same way and will not affect the difference between them. In contrast, the Coriolis forces cause the proof masses to deflect in different directions, so the changes in capacitance induced by the changes in the gaps will affect the difference measured by the differential amplifier. By using differential measurements, the inertial sensor 400 produces rotation rate measurements that are more stable over time and have lower error. The systems and methods used to measure the deflection of the proof masses of the gyroscope subassemblies 414 can be used to measure deflection in the z direction of any of the proof masses described with reference to FIGS. 1-9. The gyroscope subassemblies 414b, 414d, 414f, and 414h can include some or all of the features of the gyroscope subassemblies 266 (FIG. 2) and the gyroscope subassembly 2400 (FIG. 24).

Furthermore, the configuration of the gyroscope electrodes 426 and 428, and the manner in which they are connected to the respective first, second, third, and fourth AFE's, enables the inertial device 400 to produce analog outputs corresponding to rotation about the x and y axes, even though none of the gyroscope subassemblies 414b, 414d, 414f, and 414h are located on either the x or y axes.

The gyroscope subassemblies of the inertial device 400 are located further from the center of oscillation than the accelerometer subassemblies. This results in the gyroscope subassemblies having a larger displacement in the x-y plane due to the comb drive, a higher drive velocity, and higher Coriolis forces acting on their respective proof masses due to the higher drive velocity. Because the Coriolis forces are higher, the displacement of the proof mass induced by the Coriolis effect is also higher than if the gyroscope subassemblies were located closer to the center of oscillation. Conversely, the accelerometer subassemblies are closer to the center of oscillation and have correspondingly lower displacements in the x-y plane, lower drive velocities, lower Coriolis forces, and lower proof mass displacements due to the Coriolis effect. The ratio of the amplitudes of the gyroscope subassembly drive velocity and the accelerometers subassembly drive velocity is fixed by the dimensions of the as-fabricated inertial device, and the ratio does not vary due to external factors. In some examples, the gyroscope subassemblies are located on shorter arms and thus closer to the axis of oscillation than the accelerometer subassemblies. The locations of the gyroscope and accelerometer subassemblies can be selected based on factors such as the relative importance of the respective types of measurement to the inertial device, the relative sensitivity of the types of sensor, and space available on the chip. In some examples, the gyroscope subassemblies are located further from the center of rotation to increase displacement due to the Coriolis effect, because the Coriolis force is relatively weak. This can increase the signal-to-noise ratio. In some examples, a very accurate measurement of acceleration is desired while the accuracy of the rotation rate measurement is not as critical. In these situations, the accelerometer subassemblies would be located on longer arms and thus further from the axis of oscillation to increase the amplitude and thus the signal-to-noise ratio of the accelerometer output relative to that of the gyroscope output. In some examples, chip space is limited and one type of subassembly is located closer to the center of oscillation simply to save space. In these examples, the less critical type of sensor may be located closer, or the sensor with a sufficient signal-to-noise ratio may be located closer while the sensor with a lower signal-to-noise ratio may be located further from the center of oscillation to boost its signal.

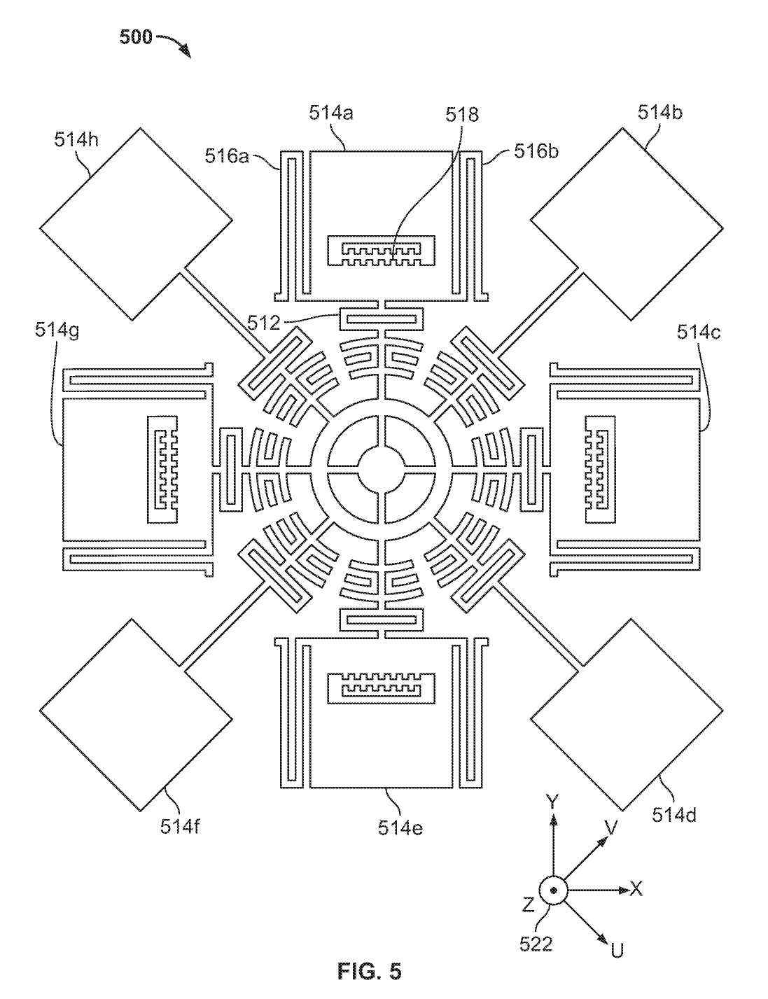

FIG. 5 depicts an inertial device 500 configured for measuring acceleration along the x and y axes and rotation about the x, y, and z axes. The inertial device 500 includes a central anchor, a rotational spring, a central frame, arms, and comb drives similar to those described with reference to FIG. 1. The inertial device 500 includes inertial subassemblies 514a, 514b, 514c, 514d, 514e, 514f, 514g, and 514h (collectively, inertial subassemblies 514).

FIG. 5 also depicts a coordinate system 522 with an x-y-z coordinate system sharing a z axis and an origin with a u-v-z coordinate system. While the coordinate system 522 is depicted offset from the inertial device 500 for clarity, the origin of the coordinate system 522 is located at the center of the central anchor of the inertial device 500. The x and y axes are orthogonal to each other. The u and v axes are orthogonal to each other and are rotated by −45 degrees from the x and y axes, respectively.

The inertial subassemblies 514a and 514e are accelerometer subassemblies and detect acceleration along the x axis. The inertial subassemblies 514c and 514g are accelerometer subassemblies as well and detect acceleration along the y axis. The accelerometer subassembly 514a includes a coupling spring 512, drive springs 516a and 516b, and a TDS structure 518. The accelerometer subassemblies 514c, 514e, and 514g also include coupling springs, drive springs, and TDS structures. The coupling springs, drive springs, and TDS structures depicted in FIG. 5 operate in a similar manner as those described with reference to FIG. 1-4 and provide similar results.

The inertial subassemblies 514b, 514d, 514f, and 514h are gyroscope subassemblies and detect rotation of the inertial device 500 about the x, y, and z axes. The gyroscope subassemblies 514b, 514d, 514f, and 514h can include some or all of the features of the gyroscope subassemblies 266 (FIG. 2); the gyroscope subassemblies 414b, 414d, 414f, and 414h (FIG. 4); and the gyroscope subassembly 2400 (FIG. 24). The inertial device 500 also includes gyroscope electrodes such as the gyroscope electrodes 426 and 428, described with reference to FIG. 4, but are not shown in FIG. 5 for clarity. The inertial device 500 does not have suspension springs such as the suspension springs 422, although in some examples the inertial device 500 could include suspension springs.

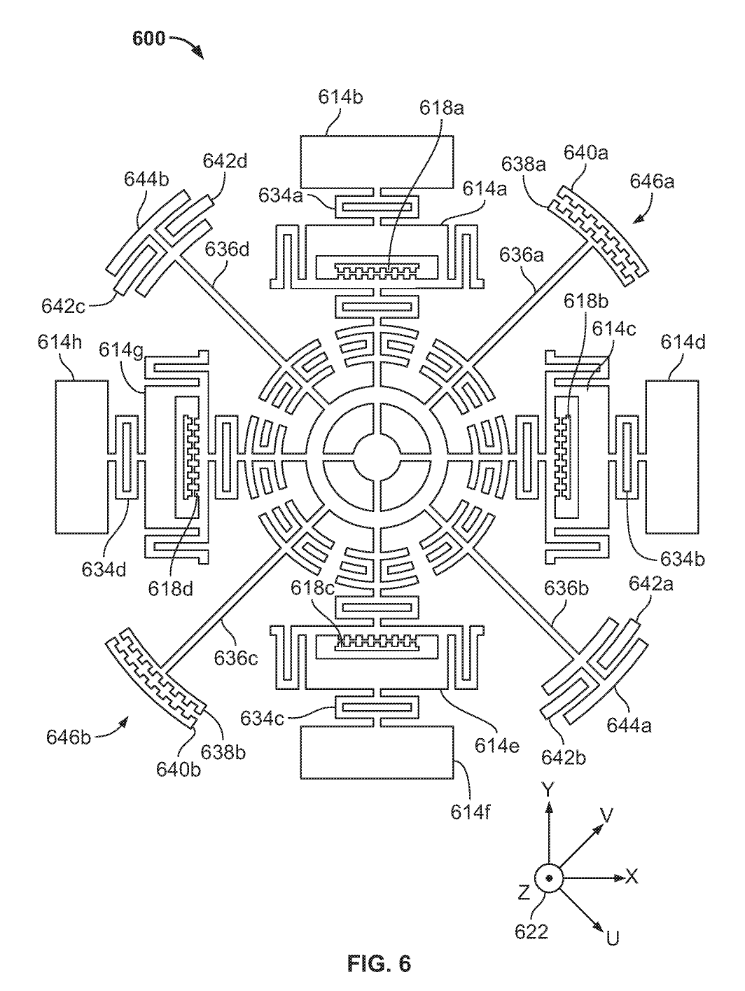

FIG. 6 depicts a multi-axis inertial device 600 with gyroscope subassemblies located radially outward from accelerometer subassemblies. The inertial device 600 includes a central anchor, a rotational spring, a comb drive, and arms similar to those described with reference to FIGS. 1-5.

FIG. 6 also depicts a coordinate system 622 with an x-y-z coordinate system sharing a z axis and an origin with a u-v-z coordinate system. While the coordinate system 622 is depicted offset from the inertial device 600 for clarity, the origin of the coordinate system 622 is located at the center of the central anchor of the inertial device 600. The x and y axes are orthogonal to each other. The u and v axes are orthogonal to each other and are rotated by −45 degrees from the x and y axes, respectively.

The inertial device 600 includes inertial subassemblies 614a, 614b, 614c, 614d, 614e, 614f, 614g, and 614h (collectively, inertial subassemblies 614). The inertial subassemblies 614a, 614c, 614e, and 614g are accelerometer subassemblies, and the inertial subassemblies 614b, 614d, 614f, and 614h are gyroscope subassemblies. The gyroscope subassemblies 614b, 614d, 614f, and 614h are located in the same circumferential positions as each of the respective accelerometer subassemblies 614a, 614c, 614e, and 614g and are located radially outward from the respective accelerometer subassemblies 614a, 614c, 614e, and 614g.

The accelerometer subassemblies 614a, 614c, 614e, and 614g each include coupling springs, drive springs similar to those described with reference to FIG. 1-5. The accelerometer subassemblies 614a, 614c, 614e, and 614g also include TDS structures 618a, 618b, 618c, and 618d (collectively, TDS structures 618) that are similar to the TDS structures described with reference to FIGS. 1-5. The gyroscope subassemblies 614b, 614d, 614f, and 614h are connected to the accelerometer subassemblies 614a, 614c, 614e, and 614g by coupling springs 634a, 634b, 634c, and 634d. In some examples, the gyroscope subassemblies 614b, 614d, 614f, and 614h can also be supported by drive springs (not shown). The gyroscope subassemblies 614b, 614d, 614f, and 614h can include some or all of the features of the gyroscope subassemblies 266 (FIG. 2); the gyroscope subassemblies 414b, 414d, 414f, and 414h (FIG. 4); and the gyroscope subassembly 2400 (FIG. 24). In some examples, the accelerometer subassemblies include suspension springs to adjust the natural frequency of the corresponding proof masses.

The inertial device 600 includes TDS structures 646a and 646b (collectively, TDS structures 646). The TDS structure 646a comprises a movable element 638a that is connected to the arm 636a and a fixed element 640a adjacent to the movable element 638a. The TDS structure 646b includes a movable element 638b connected to the arm 636c and a fixed element 640b adjacent to the movable element 638b. The inertial device 600 includes arms 636a, 636b, 636c, and 636d (collectively, arms 636). The arms 636 are attached to the comb drive and oscillate with it. The arms 636a and 636c are connected to movable TDS elements 638a and 638b (collectively, movable TDS elements 638). The fixed TDS elements 640a and 640b are collectively referred to as fixed TDS elements 640. The motion of the movable TDS elements 638 relative to the respective fixed TDS elements 640 can be detected using the systems and methods described with reference to FIG. 10-23 to determine drive velocity of the comb drive and the arms 636.

The inertial device 600 includes fixed combs 642a, 642b, 642c, and 642d (collectively, fixed combs 642). The inertial device 600 also includes movable combs 644a and 644b (collectively, movable combs 644). The arms 636b and 636d are connected to movable combs 644a and 644b, respectively. The movable comb 644a is adjacent to fixed combs 642a and 642b, and the movable comb 644b is adjacent to fixed combs 642c and 642d. The motion of the movable combs 644 relative to the fixed combs 642 causes a change in capacitance between the respective adjacent combs. This change in capacitance can be measured to determine the amplitude and velocity of the motion of the movable combs 644. In some examples, an AC voltage can be applied between the fixed combs 642 and the movable combs 644 to drive the inertial device 600. In either example, the combs 642 and 644 are more effective because of the increased distance from the axis of oscillation. When used as sensors, the combs 642 and 644 experience a higher amplitude and thus a higher change in capacitance, resulting in a higher signal-to-noise ratio. When used as comb drives, the combs 642 and 644 exert a higher torque upon the inertial device 600 thus enabling higher drive velocities for the same power required.

In some examples, one of the combs 644 is used as a comb drive and the other is used as a sensor. In some examples, the sensor output is used to regulate the velocity of the comb drives of the inertial device 600. In some examples, the TDS structures comprising the movable TDS elements 638 and the fixed TDS elements 640 are used to measure drive velocity for use in determining the external rotation applied to the inertial device 600. The input rotation rate of the inertial device 600 is determined based on the drive velocity and the Coriolis-induced displacement of one or more proof masses of the gyroscope subassemblies. Thus, improving the accuracy of the drive velocity measurement improves the accuracy of the rotation rate measurement of the inertial device 600. In some examples, TDS structures can measure drive velocity more accurately than comb structures, so the TDS structures 646 can improve the accuracy of the rotation rate measured by the inertial device 600. In some examples, the velocity measured using one or more of the TDS structures 646 can be used to regulate the drive velocity in closed-loop control.

In some examples, the combs 642 and 644 and the TDS structures 646 are not connected to the inner comb drives by the arms 636, but instead by a monolithic drive frame that surrounds and is coupled to the inertial subassemblies 614. In some examples, the drive frame is coupled to the inertial subassemblies 614 with coupling springs. The gyroscope subassembly 600 also includes gyroscope electrodes (not shown) such as the gyroscope electrodes 426 and 428, described with reference to FIG. 4. In some examples, the inertial device 600 includes suspension springs similar to the suspension springs 422.

One benefit of locating the gyroscope subassemblies radially outward from the accelerometer subassemblies is that this leaves additional space in the sectors between the inertial subassemblies for ancillary structures, such as the combs 642 and 644 and the TDS structures 646. In some examples, the locations of the accelerometer subassemblies and the gyroscope subassemblies are reversed such that the accelerometer subassemblies are located radially outward from the gyroscope subassemblies. This configuration may be used for applications in which the accelerometer signal is more critical than the gyroscope signal, or when a larger oscillation amplitude is desired for the accelerometer subassemblies than for the gyroscope subassemblies. In some examples, some gyroscope subassemblies are located radially outward from accelerometer subassemblies, while other gyroscope subassemblies are located radially inward from other accelerometer subassemblies. This configuration may be used for applications in which the accelerometer and gyroscope signals are equally critical, and/or situations in which equal average oscillation amplitudes are desired. By locating the gyroscope subassemblies radially adjacent to respective accelerometer subassemblies, oscillation amplitude ratios can be selected based on the application while reserving the sectors between for ancillary structures.

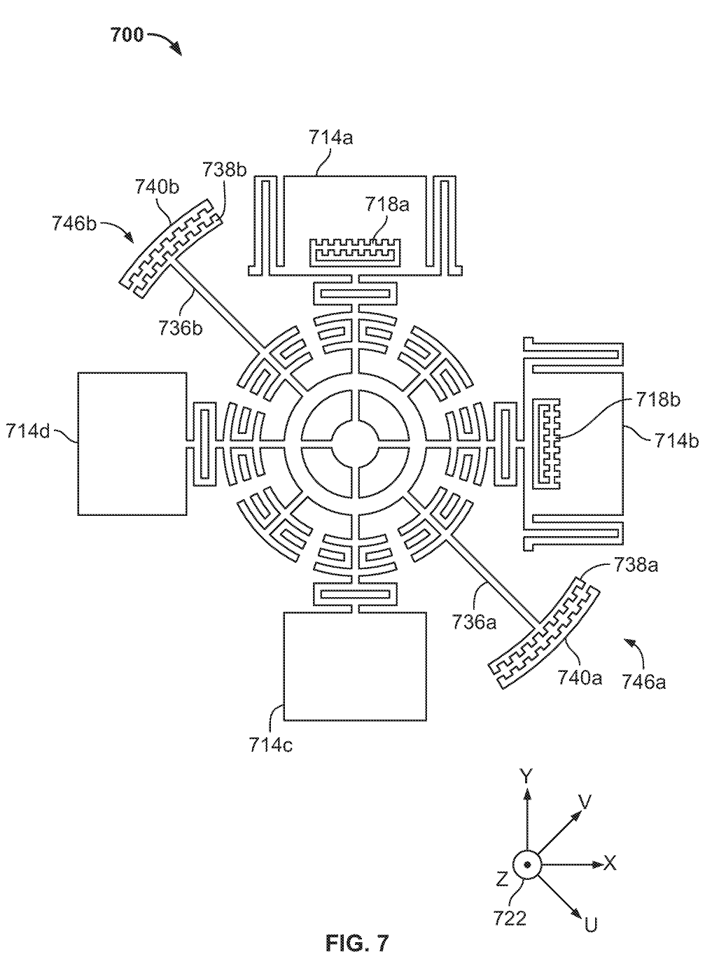

FIG. 7 depicts an inertial device 700 that uses single-ended measurement. The inertial device 700 includes inertial subassemblies 714a, 714b, 714c, and 714d (collectively, inertial subassemblies 714). The inertial subassemblies 714a and 714b are accelerometer subassemblies, and the inertial subassemblies 714c and 714d are gyroscope subassemblies. The gyroscope subassemblies 714c and 714d can include some or all of the features of the gyroscope subassemblies 266 (FIG. 2); the gyroscope subassemblies 414b, 414d, 414f, and 414h (FIG. 4); and the gyroscope subassembly 2400 (FIG. 24).

FIG. 7 also depicts a coordinate system 722 with an x-y-z coordinate system sharing a z axis and an origin with a u-v-z coordinate system. While the coordinate system 722 is depicted offset from the inertial device 700 for clarity, the origin of the coordinate system 722 is located at the center of the central anchor of the inertial device 700. The x and y axes are orthogonal to each other. The u and v axes are orthogonal to each other and are rotated by −45 degrees from the x and y axes, respectively.

The inertial device 700 includes TDS structures 746a and 746b (collectively, TDS structures 746). The TDS structures 746a and 746b are connected to the comb drive by arms 736a and 736b, respectively. The TDS structure 746a includes a movable element 738a and a fixed element 740a. Likewise, the TDS structure 746b includes a movable element 738b and a fixed element 740b. In some examples, the inertial device 700 does not include the TDS structures 746, but instead includes comb structures at the respective ends of the arms 736a and 736b (collectively, arms 736). These comb structures can be used for drive velocity measurement, as drive combs, or both. In some examples, the inertial device 700 includes a TDS structure at the end of the one of the arms 736 and a comb structure at the end of the other of the arms 736. In some examples, one of the TDS structure and the comb structure can be used for drive velocity measurement and the other can be used drive comb regulation. In some examples, the inertial device includes additional arms (not shown), each with TDS or comb structures at the end.

The inertial device 700 includes a central anchor, a rotational spring, a comb drive, and arms as described with reference to FIGS. 1-6. The accelerometer subassemblies 714a and 714b each include coupling springs, drive springs, and TDS structures 718a and 718b similar to those described with reference to FIG. 1-6. In some examples, the gyroscope subassemblies 714c and 714d can also be supported by drive springs (not shown). In some examples, the accelerometer subassemblies include suspension springs to adjust the natural frequencies of the corresponding proof masses.

Because the inertial device 700 only includes one accelerometer subassembly and one gyroscope subassembly located on each of the x and y axes of the inertial device 700, the inertial device 700 operates by taking single-ended measurements only. The single-ended measurements do not cancel common-mode noise as differential measurements do, but because fewer inertial subassemblies are required, the inertial device 700 can be more compact than an inertial device capable of differential measurements. This compactness can be beneficial when chip area is at a premium, such as when a small or low-powered device is required. The single-ended measurements are taken by using one or more common potentials when measuring the output signals of the inertial subassemblies 714. In the single-ended measurement scheme, the respective outputs of the inertial subassemblies 714 are compared (such as with a potential measurement) to a common potential with signal processing circuitry used to measure the respective outputs. This can be contrasted with a differential measurement, in which the output of one inertial subassembly is compared to an output of another inertial subassembly (such as with a potential measurement). By using single-ended measurement instead of differential measurement, the inertial device 700 is a more compact device.

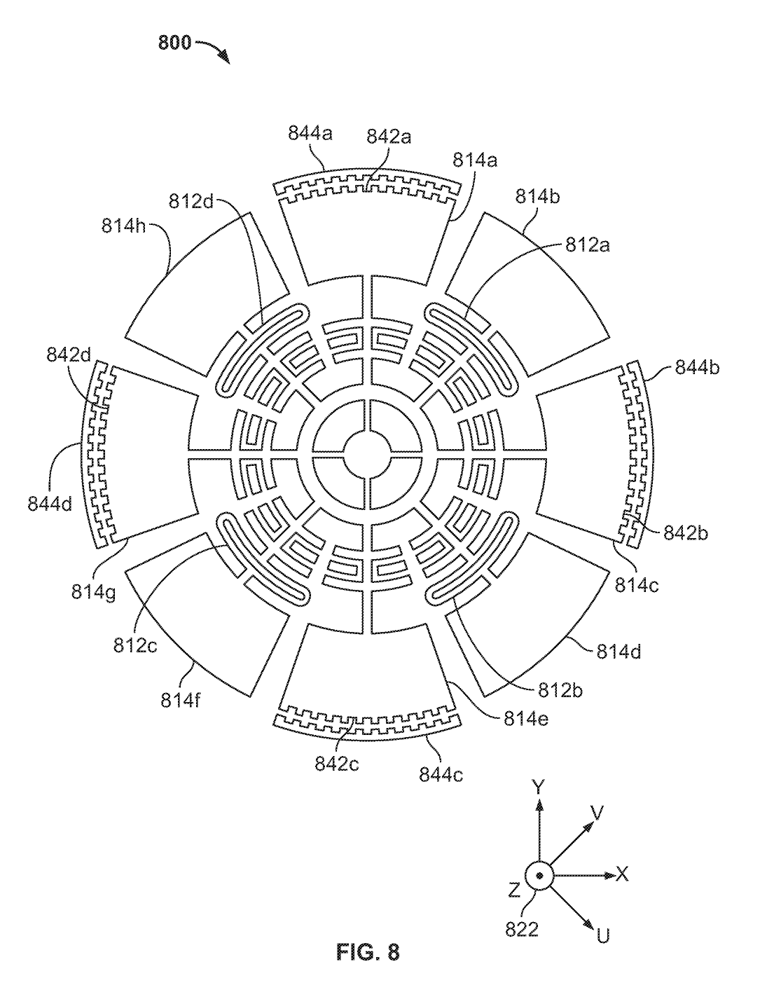

FIG. 8 depicts an inertial device 800 with gyroscope and TDS subassemblies. The inertial device 800 includes inertial subassemblies 814a, 814b, 814c, 814d, 814e, 814f, 814g, 814h (collectively, inertial subassemblies 814). The inertial subassemblies 814a, 814c, 814e, and 814g are TDS subassemblies, and the inertial subassemblies 814b, 814d, 814f, and 814h are gyroscope subassemblies. The inertial device 800 also includes a central anchor, a rotational spring, a comb drive, and arms as described with reference to FIGS. 1-7.

FIG. 8 also depicts a coordinate system 822 with an x-y-z coordinate system sharing a z axis and an origin with a u-v-z coordinate system. While the coordinate system 822 is depicted offset from the inertial device 800 for clarity, the origin of the coordinate system 822 is located at the center of the central anchor 802. The x and y axes are orthogonal to each other. The u and v axes are orthogonal to each other and are rotated by −45 degrees from the x and y axes, respectively.

The inertial device 800 includes movable TDS elements 842a, 842b, 842c, and 842d (collectively, movable TDS elements 842) and fixed TDS elements 844a, 844b, 844c, and 844d (collectively, fixed TDS elements 844). The movable TDS elements 842 are each disposed on a respective one of the TDS subassemblies 814a, 814c, 814e and 814g. Each of the fixed TDS elements 844 is adjacent to a respective one of the movable TDS element 842. The movable TDS elements 842 and the fixed TDS elements 844 are configured to measure drive velocity of the inertial device 800 using the systems and methods described with reference to FIG. 10-23. The TDS structures of the inertial device 800 are depicted schematically in FIG. 8 and may include variations from the depicted geometry.

The gyroscope subassemblies 814b, 814d, 814f, and 814h are connected to the comb drive by coupling springs 812a, 812b, 812c, and 812d (collectively, coupling springs 812, respectively). In some examples, the gyroscope subassemblies 814b, 814d, 814f, and 814h can also be supported by drive springs (not shown). The gyroscope subassemblies 814b, 814d, 814f and 814h can include gyroscope electrodes (not shown) such as the gyroscope electrodes 426 and 428, described with reference to FIG. 4. The gyroscope subassemblies 814b, 814d, 814f, and 814h can include some or all of the features of the gyroscope subassemblies 266 (FIG. 2); the gyroscope subassemblies 414b, 414d, 414f, and 414h (FIG. 4); and the gyroscope subassembly 2400 (FIG. 24). The TDS subassemblies 814a, 814c, 814e, and 814g can be used for velocity measurements, drive comb regulation, or both. By combining four gyroscope subassemblies with TDS subassemblies for velocity measurements, the inertial device 800 results in a compact and accurate three-axis gyroscope.

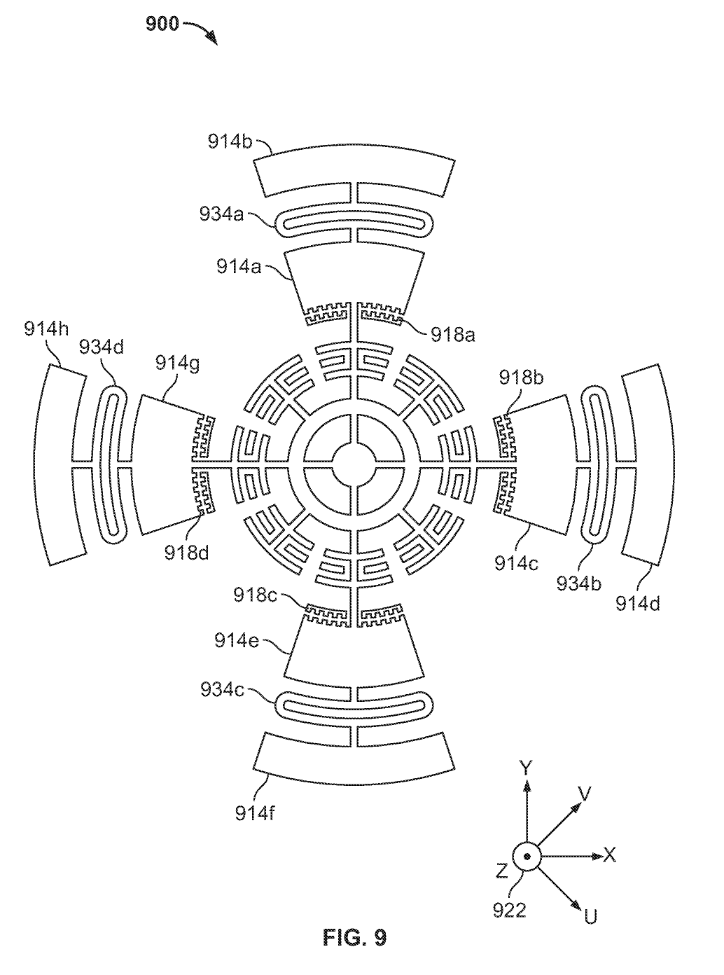

FIG. 9 depicts an inertial device 900 with four gyroscope subassemblies and four TDS subassemblies. The inertial device 900 includes inertial subassemblies 914a, 914b, 914c, 914d, 914e, 914f, 914g, and 914h (collectively, inertial subassemblies 914). The inertial subassemblies 914a, 914c, 914e, 914g are TDS subassemblies, and the inertial subassemblies 914b, 914d, 914f, and 914h are gyroscope subassemblies. The inertial device 900 includes a central anchor, a rotational spring, a central frame, a comb drive, and arms similar to those described with reference to FIGS. 1-8.

FIG. 9 also depicts a coordinate system 922 with an x-y-z coordinate system sharing a z axis and an origin with a u-v-z coordinate system. While the coordinate system 922 is depicted offset from the inertial device 900 for clarity, the origin of the coordinate system 922 is located at the center of the central anchor 902. The x and y axes are orthogonal to each other. The u and v axes are orthogonal to each other and are rotated by −45 degrees from the x and y axes, respectively.

The TDS subassemblies 914a, 914c, 914e, and 914g contain TDS structures 918a, 918b, 918c, and 918d (collectively, TDS structures 918) similar to those described to with reference to FIGS. 1-8 and can be used for measuring drive velocity for use in Coriolis force calculation, for comb drive regulation, or both. In some examples, some of the combs of the comb drive are used for drive velocity measurement and/or comb drive regulation. In some examples, the inertial device 900 does not include TDS subassemblies 914a, 914c, 914e, and 914g and uses only combs of the comb drive for drive velocity measurement and/or drive comb regulation.

The inertial device 900 includes coupling springs 934a, 934b, 934c, and 934d (collectively, coupling springs 934) which connect the gyroscope subassemblies 914b, 914d, 914f, and 914h to the TDS subassemblies 914a, 914c, 914e, and 914g, respectively. The gyroscope subassemblies 914b, 914d, 914f, and 914h include gyroscope electrodes (not shown) such as the gyroscope electrodes 426 and 428, described with reference to FIG. 4. In some examples, the gyroscope subassemblies 914b, 914d, 914f, and 914h can also be supported by drive springs (not shown). The gyroscope subassemblies 914b, 914d, 914f, and 914h can include some or all of the features of the gyroscope subassemblies 266 (FIG. 2); the gyroscope subassemblies 414b, 414d, 414f, and 414h (FIG. 4); and the gyroscope subassembly 2400 (FIG. 24). The gyroscope subassemblies 914b, 914d, 914f, and 914h are located relatively far from the axis of rotation compared to the other features of the inertial device 900. This results in higher drive amplitudes and higher drive velocities for the gyroscope subassemblies, which in turn results in larger displacements of their respective proof masses due to the Coriolis effect. These larger displacements may result in higher signal-to-noise ratios for the output signals of the gyroscope subassemblies.

In some examples, the gyroscope subassemblies 914b, 914d, 914f, and 914h have different geometries than depicted in FIG. 9. In particular, the gyroscope subassemblies 914b, 914d, 914f, and 914h can extend laterally to occupy more space. This enlargement of the gyroscope subassemblies 914b, 914d, 914f, and 914h results in larger electrode area available for measuring of the displacement of the proof masses of the gyroscope subassemblies 914b, 914d, 914f, and 914h. This larger area results in higher amplitudes of the respective output signals and higher signal-to-noise ratios.

In some examples, the TDS subassemblies 914a, 914c, 914e, and 914g can extend laterally. This lateral extension can result in longer rows of teeth and/or additional rows of teeth. This increases the amplitude of the output signals and results in higher signal-to-noise ratios. In some examples, the sectors between the inertial subassemblies 914 can be occupied by comb structures or additional TDS structures for one or both of drive velocity measurement, comb drive regulation, or comb drives. The gyroscope subassemblies 914b, 914d, 914f, and 914h can be placed at distances from the axis of oscillation that are selected to result in a desired oscillation amplitude. Because the gyroscope subassemblies are located far from the axis of oscillation, the inertial device 900 is a multi-axis gyroscope with high sensitivity.

The central anchor, the rotational spring, the central frame, the arms, the comb drives, the TDS structures, the drive springs, the coupling springs, the suspension springs, the proof masses, the gyroscope electrodes, the gyroscope subassemblies, and the accelerometer subassemblies depicted in FIGS. 1-9 are depicted schematically to indicate the general layout of the respective inertial sensors and relative positioning of the components. However, the geometric details may not be reproduced to scale in FIGS. 1-9 and the inertial sensors may contain some departures therefrom. For example, the comb drives may have a greater or lesser number of interdigitated combs and may be arranged in multiple rows of combs, where only one or two rows of combs may be depicted. As another example, the TDS structures may include a greater or lesser number of teeth than depicted and may include multiple rows of teeth, each row disposed on a separate beam. These beams may be parallel and interdigitated to amplify the signal-to-noise ratio of the TDS structure. The inertial subassemblies may have different shapes than depicted. The proof masses of the inertial subassemblies may have different shapes, locations, or orientations than depicted. As another example, the rotational springs may include complex geometry to provide a linear or quasi-linear relationship between torque and angular displacement, but are depicted in FIGS. 1-9 with simple geometry for clarity of illustration. As another example, the arms connecting the inertial subassemblies and ancillary structures to the comb drives are also schematically depicted and in some examples may have different geometry than depicted. In some examples, one or more drive frames may connect the inertial subassemblies and ancillary structures to the comb drives, central frame, and/or the rotational spring. This drive frame may be a monolithic structure that occupies more planform area and provides greater rigidity. In some examples, TDS structures and/or comb structures are located on the periphery of the drive frame.

FIG. 10 depicts three views 1000, 1030, and 1060, each showing a schematic representation of parts of a movable element 1002 and a fixed element 1004. A TDS structure (e.g., TDS structures 118, 260, 418, 518, 618, 718, 842, 844, and 918) can include the movable element 1002 and the fixed element 1004. The oscillating mass of the TDS structure (e.g., 118, 260, 418, 518, 618, 718, 842, 844, and 918) can include the movable element 1002. The movable element 1002 and the fixed element 1004 depicted in FIG. 10 each include a plurality of structures, or beams. In particular, the fixed element 1004 includes beams 1006a, 1006b, and 1006c (collectively, beams 1006). The movable element 1002 depicted in FIG. 10 includes beams 1008a and 1008b (collectively, beams 1008). The movable element 1002 is separated from the fixed element 1004 by a distance W0 1032. The distance W0 1032 can change as the movable element 1002 oscillates with respect to the fixed element 1004. The distance W0 1032 affects parasitic capacitance between the movable element 1002 and the fixed element 1004.

The distance W0 1032 is selected to minimize parasitic capacitance when the movable element 1002 is in the rest position, while maintaining manufacturability of the sensor. The view 1060 depicts an area of interest noted by the rectangle 1040 of view 1030. FIG. 10 depicts an example of a TDS structure (e.g., TDS structures 118, 260, 418, 518, 618, 718, 842, 844, and 918) with teeth on parallel beams. In other examples, TDS structures (e.g., TDS structures 118, 260, 418, 518, 618, 718, 842, 844, and 918) include teeth on other geometries. However, the same general principles described with reference to FIGS. 10-23 apply to TDS structures (e.g., TDS structures 118, 260, 418, 518, 618, 718, 842, 844, and 918) with other geometries.

Each of the beams 1006 and 1008 includes multiple sub-structures, or teeth, protruding perpendicularly to the long axis of the beams. The beam 1006b includes teeth 1010a, 1010b, and 1010c (collectively, teeth 1010). The beam 1008b includes teeth 1012a, 1012b and 1012c (collectively, teeth 1012). Adjacent teeth on a beam are equally spaced according to a pitch 1062. Each of the teeth 1010 and 1012 has a width defined by the line width 1066 and a depth defined by a corrugation depth 1068. Opposing teeth are separated by a tooth gap 1064. As the movable beam 1008b oscillates along the moving axis 1001 with respect to the fixed beam 1006b, the tooth gap 1064 remains unchanged. In some examples, manufacturing imperfections cause the tooth spacing to deviate from the pitch 1062. However, provided that the deviation is negligible compared to the pitch 1062, the deviation does not significantly impact operation of the sensor and can be neglected for the purposes of this disclosure.

A capacitance exists between the fixed beam 1006b and the movable beam 1008b. As the movable beam 1008b oscillates along the moving axis 1001 with respect to the fixed beam 1006b, the capacitance changes. The capacitance increases as opposing teeth of the teeth 1010 and 1012 align with each other and decreases as opposing teeth become less aligned with each other. At the position depicted in the view 1060, the capacitance is at a maximum and the teeth 1010 are in an aligned position with respect to the teeth 1012. As the movable beam moves monotonically along the moving axis 1001, the capacitance changes non-monotonically, since a maximum in capacitance occurs as the teeth are in an aligned position.

The capacitance can be degenerate, meaning that the same value of capacitance can occur at different displacements of the movable beam 1008b. When the movable beam 1008b has moved from its rest position by a distance equal to the pitch 1062, the capacitance is the same as when the movable beam 1008b is in the rest position.

FIG. 11 schematically depicts an exemplary process used to extract inertial information from an inertial sensor with periodic geometry. FIG. 11 includes an inertial sensor 1100 which experiences an external perturbation 1101. The inertial sensor 1100 can include the system 100, and the external perturbation 1101 can include the input inertial parameter 102. A drive signal 1110 causes a movable portion of the sensor 1100 to oscillate. The movable portion can be the movable element 1002. An analog front end (AFE) electrically connected to the movable element 1002 and to the fixed element 1004 measures the capacitance between them and outputs a signal based on the capacitance. The AFE can do this by measuring a capacitive current or a charge. Zero-crossings of the AFE output signal occur when the AFE output signal momentarily has a magnitude of zero. Zero-crossings of an output signal from the inertial sensor 1100 are generated at 1102 and 1104 and combined at 1106 into a combined signal. A signal processing module 1108 processes the combined analog signal to determine inertial information. One or more processes can convert the combined analog signal into a rectangular waveform 1112. This can be accomplished using a comparator, by amplifying the analog signal to the rails, or by other methods.

The rectangular waveform 1112 comprises a rectangular pulse stream having high and low values, with no substantial time spent transitioning between high and low values. Transitions between high and low values correspond to zero-crossings of the combined analog signal. The transitions between high and low values and zero-crossings occur when a displacement 1118 of the movable element 1002 crosses reference levels 1114 and 1116. The reference levels 1114 and 1116 correspond to physical locations of movable portions of the sensor 1100. Because the zero-crossings are associated with specific physical locations, displacement information can be reliably determined independent of drift, creep and other factors which tend to degrade performance of inertial sensors.

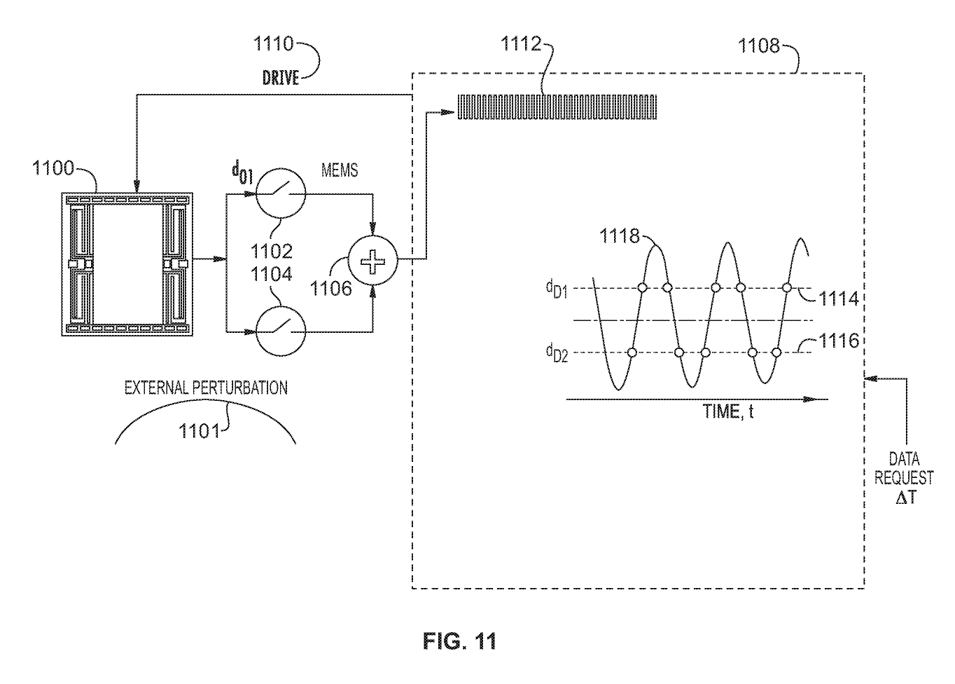

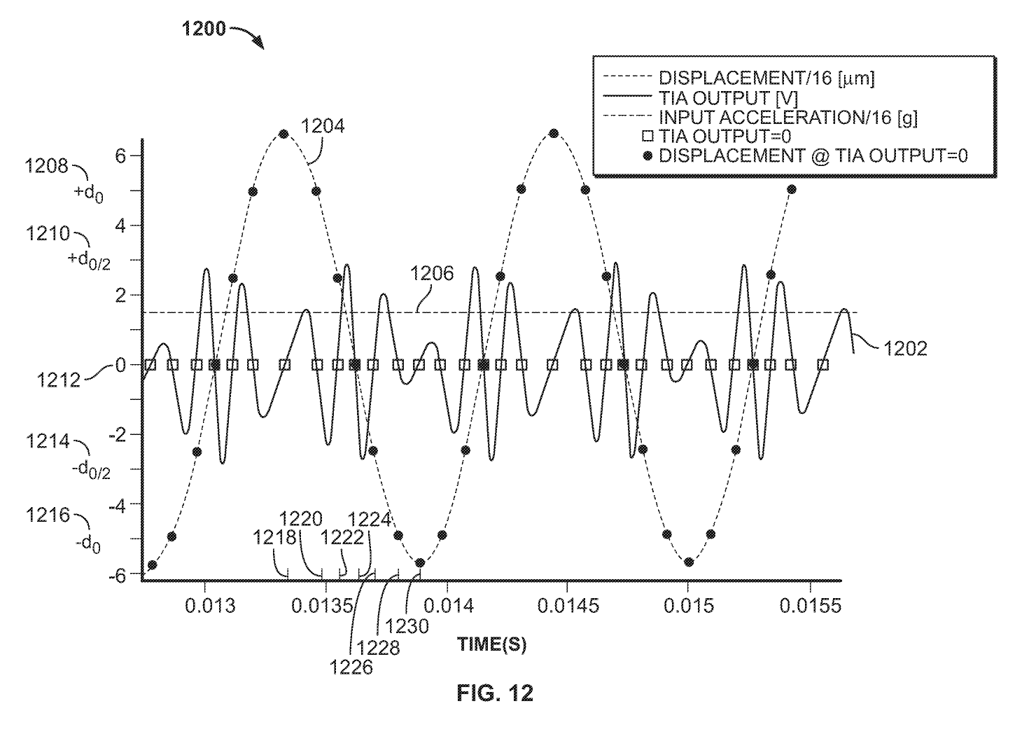

FIG. 12 depicts a graph 1200 which represents the association of analog signals derived from the inertial sensor 1100 with zero-crossing times and displacements of the inertial sensor. The graph 1200 represents signals derived from an oscillator in which opposing teeth are aligned at the rest position. The graph 1200 includes curves 1202, 1204 and 1206. The curve 1202 represents an output of an AFE such as a transimpedance amplifier (TIA). Since a TIA outputs a signal proportional to its input current, the curve 1202 represents a capacitive current measured between movable and fixed elements of an inertial device such as the inertial device 1100. The curve 1206 represents an input acceleration that is applied to the inertial device 1100. The input acceleration represented by the curve 1206 is a 15 g acceleration at 20 Hz. The curve 1204 represents displacement of the movable element of the inertial device 1100 as it oscillates.

FIG. 12 includes square symbols indicating points on the curve 1202 at which the curve 1202 crosses the zero level. These zero-crossings in the current represent local maxima or minima (extrema) of capacitance between the movable element and the fixed element of the inertial device, because capacitive current is proportional to the first derivative of capacitance. FIG. 12 includes circular symbols indicating points on the curve 1204 corresponding to times at which the curve 1202 crosses zero. The circular symbols indicate the correlation between physical position of a movable element of the oscillator and zero-crossing times of the outputs of signal 1202.

At time 1218, the curve 1202 crosses zero because the displacement of the movable element of the oscillator is at a maximum and the oscillator is at rest, as indicated by the displacement curve 1204. Here, capacitance reaches a local extremum because the movable element has a velocity of zero, not necessarily because teeth or beams of the oscillator are aligned with opposing teeth or beams. At time 1220, the TIA output curve 1202 crosses zero because the oscillator displacement reaches the +d₀ location 1208. The +d₀ location 1208 corresponds to a displacement in a positive direction equal to the pitch distance and is a point at which opposing teeth or beams are aligned to produce maximum capacitance. At time 1222, the TIA output curve 1202 crosses zero because the movable element of the oscillator is at a position at which the teeth are anti-aligned. This occurs when the teeth of the movable element 1002 (FIG. 10) are in an aligned position with the centers of gaps between teeth of the fixed element 1004 (FIG. 10), resulting in a minimum in capacitance. This minimum in capacitance occurs at a location of +d₀/2 1210, corresponding to a displacement to one-half the pitch distance in the positive direction.

At time 1224, the TIA output curve 1202 crosses zero because teeth of the movable element 1002 (FIG. 10) are aligned with teeth of the fixed element 1004 (FIG. 10), producing a maximum in capacitance. The time 1224 corresponds to a time at which the movable element is at the rest position, indicated by the zero displacement 1212 on the curve 1204. At time 1226, the TIA output 1302 crosses zero because teeth of the movable element 1002 (FIG. 10) are anti-aligned with teeth of the fixed element 1004 (FIG. 10), producing a local minimum in capacitance. This anti-alignment occurs at a displacement of −d₀/2 1214, corresponding to a displacement of one-half the pitch distance in the negative direction.

At time 1228, the TIA output 1202 crosses zero because the teeth of the movable element 1002 (FIG. 10) are in an aligned position with respect to the teeth of the fixed element 1004 (FIG. 10), creating a local maximum in capacitance. This local maximum in capacitance occurs at a displacement of −d₀ 1216, corresponding to a displacement equal to such distance in the negative direction. At time 1230, the TIA output curve 1202 crosses zero because the movable element 1002 (FIG. 10) has a velocity of zero as it reverses direction. This reversal of direction is illustrated by the displacement curve 1204. As at time 1218, when the movable element has a velocity of zero, capacitance is not changing with time and thus the current and TIA output (which are proportional to the first derivative of capacitance) are zero.

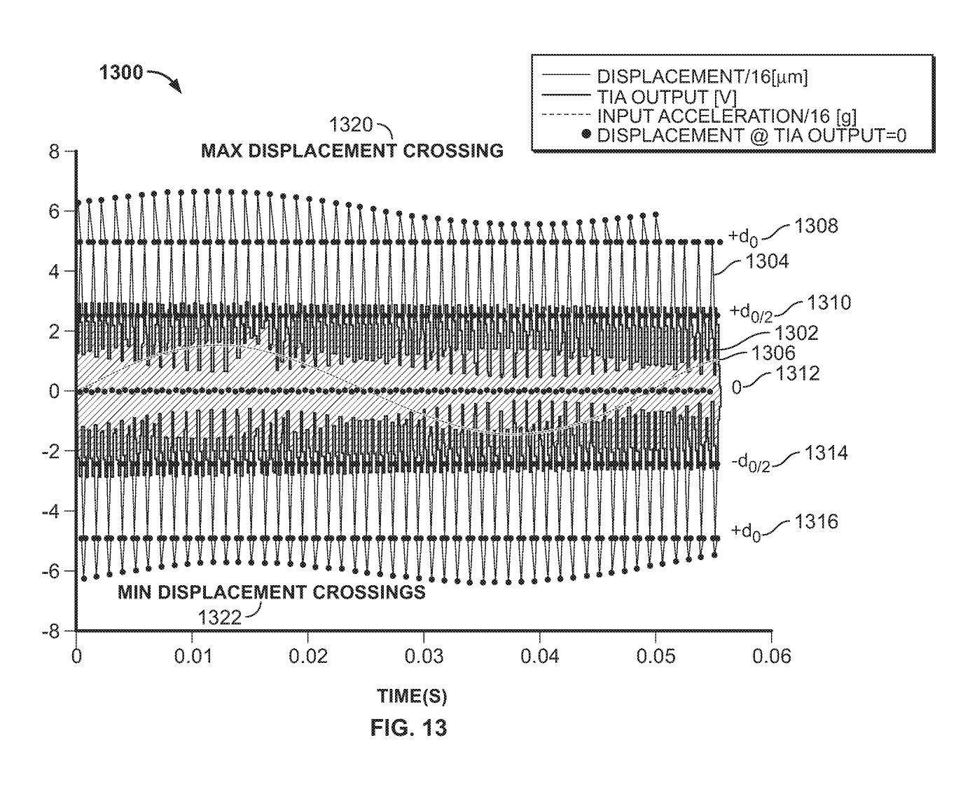

FIG. 13 depicts a graph 1300 showing the effect of an external perturbation on input and output signals of the inertial sensors described herein. The graph 1300 includes a TIA output curve 1302, a displacement curve 1304, and a input acceleration curve 1306. The graph 1300 depicts the same signals depicted in the graph 1200, and the only difference is that the graph 1300 represents a longer duration of time than the graph 1200. With a longer duration of time displayed in the graph 1300, the periodicity of the input acceleration curve 1306 is more easily discerned. In addition, maximum displacement crossings 1320 and minimum displacement crossings 1322 can be discerned in the graph 1300 to experience a similar periodicity. In contrast to the maximum displacement crossings 1320 and the minimum displacement crossings 1322, the amplitude of which varies with time, zero-crossings of the TIA output signal 1302 triggered by alignment or anti-alignment of teeth of the fixed and movable elements 1004 (FIG. 10) and 1002 (FIG. 10) at the locations +d₀/2 1308, 0 1312, −d₀/2 1314, and −d₀ 1316 are stable with time. These reference crossings, the amplitude of which are stable with time, provide stable, drift-independent indications of oscillator displacement and can be used to extract inertial parameters.

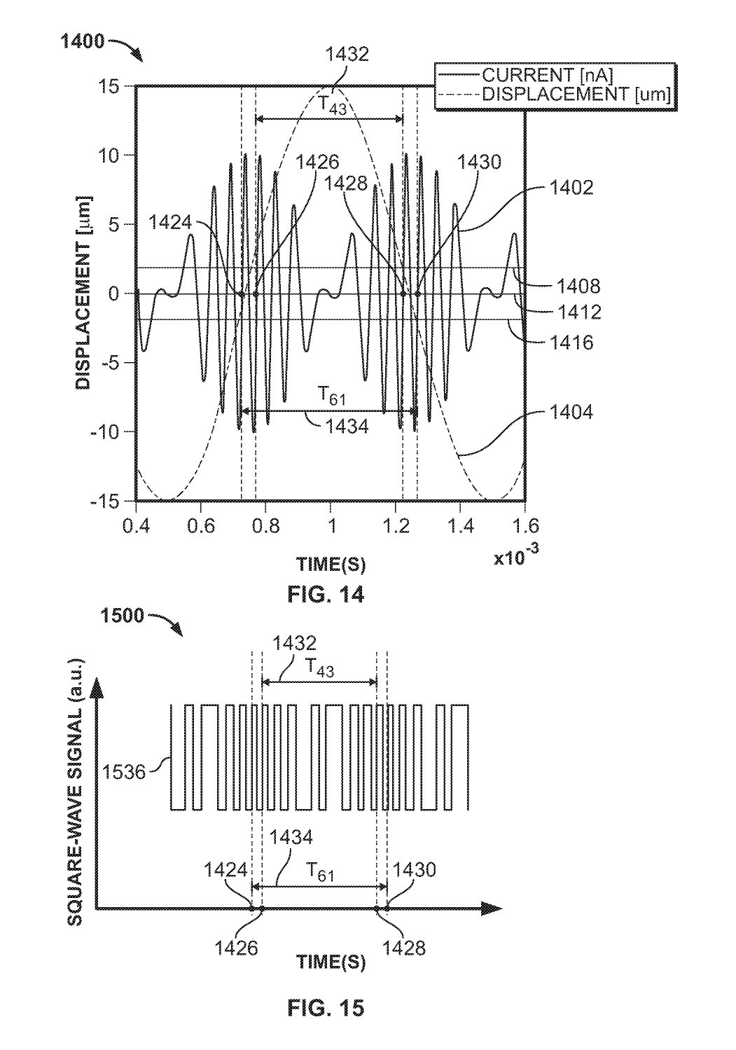

FIG. 14 depicts a graph 1400 that illustrates the response of a current to an oscillator displacement. The graph 1400 includes a current curve 1402 and a displacement curve 1404. The current curve 1402 represents an input signal for a TIA. The TIA may produce an output signal such as either of the TIA output curves 1202 or 1302 in response. The current curve 1402 is a capacitive current between the fixed beam 1004 (FIG. 10) and the movable beam 1002 (FIG. 10) in response to displacement of the movable beam 1002 (FIG. 10) according to the displacement curve 1404. The current curve 1402 crosses zero at numerous times, including times 1424, 1426, 1428, and 1430. At the times 1424 and 1430, the movable element 1002 (FIG. 10) has a displacement of −d₀, as shown in the graph 1400. At the times 1426 and 1428, the movable element 1002 (FIG. 10) has a displacement of +d₀, shown on the graph 1400.

The graph 1400 includes two time intervals T₄₃ 1432 and T₆₁ 1434. The time interval T₄₃ 1432 corresponds to the difference in time between time 1426 and time 1428. The time interval T₆₁ 1434 corresponds to the time difference between times 1424 and 1430. Thus, time interval T₆₁ 1434 corresponds to the time between subsequent crossings of the −d₀ 1416 level, and the time interval T₄₃ 1432 corresponds to the time interval between subsequent crossings of the +d₀ 1408 level. The methods used to determine the time intervals T₄₃ 1432 and T₆₁ 1434 can be used to determine other time intervals, such as between a crossings of the +d₀ 1408 level and the next subsequent crossing of the −d₀ 1416 level, between a time interval between a crossing of the −d₀ 1416 level and the next crossing of the +d₀ 1408 level, between the time 1430 and the next crossing of the +d₀ 1408 level, between crossings of the zero 1412 level, between zero-crossings due to a maximum or minimum of displacement, or between any other combination of zero-crossings of the current curve 2002 or a TIA output signal corresponding to the current curve 1402.

FIG. 15 depicts a graph 1500 showing a rectangular waveform signal representing zero-crossing times of the current signal 1402. The graph 1500 includes a rectangular waveform curve 1536. The rectangular waveform curve 1536 has substantially two values: a high value and a low value. While the rectangular waveform curve 1536 may have intermediate values as it transitions between the high and low values, the time spent at intermediate values is far less than the combined time spent at the high and low of the values.

The rectangular waveform curve 1536 can be produced by a variety of methods, including using a comparator to detect changes in an input signal, by amplifying an input signal to the limits of an amplifier so as to saturate the amplifier (amplifying to the rails), by using an analog-to-digital converter, and the like. One way to produce this rectangular waveform curve 1536 from the current curve 1402 is to use a comparator to detect zero-crossings of the current curve 1402. When the current curve 1402 has a value greater than a reference level (such as zero), the comparator outputs a high value, and when the current curve 1402 has a value less than the reference level (such as zero), the comparator has a low value. The comparator's output transitions from low to high when the current curve 1402 transitions from a negative value to a positive value, and the comparator's output transitions from high to low when the current curve 1402 transitions from a positive value to a negative value. Thus, times of rising edges of the rectangular waveform curve 1536 correspond to times of negative-to-positive zero-crossings of the current curve 1404, and falling edges of the rectangular waveform curve 1536 correspond to positive-to-negative zero-crossings of the current curve 1402.

The rectangular waveform curve 1536 includes the same time intervals 1432 and 1434 as the current curve 1402. One benefit of converting the current curve 1402 to a rectangular waveform signal such as the rectangular waveform curve 1536 is that in a rectangular waveform signal, rising and falling edges are steeper. Steep rising and falling edges provide more accurate resolution of the timing of the edges and lower timing uncertainty. Another benefit is that rectangular waveform signals are amenable to digital processing.

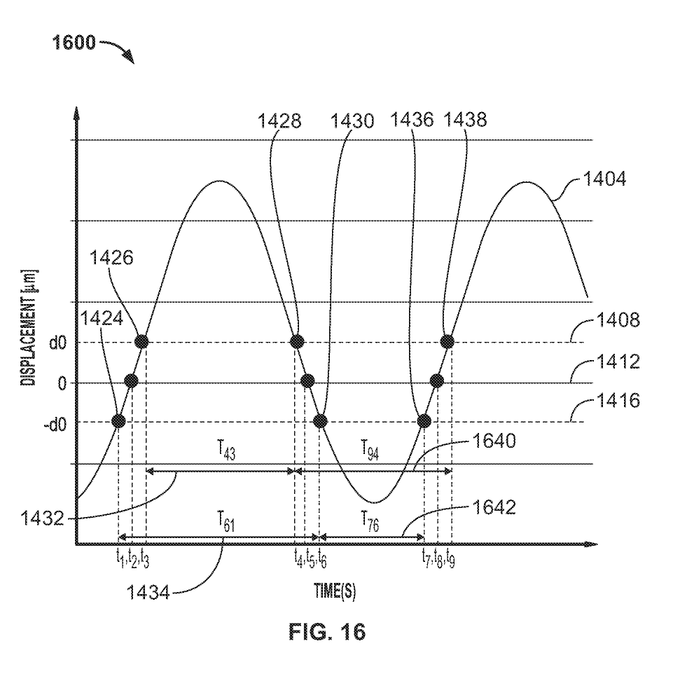

FIG. 16 depicts a graph 1600 which illustrates additional time intervals of displacement curve 1404. In addition to the times depicted in the graph 1400, the graph 1600 includes times 1636 and 1638. In addition to the time intervals depicted in the graph 1400, the graph 1600 includes the time interval T₉₄ 1640 and the time interval T₇₆ 1642. The time interval T₉₄ 1640 corresponds to the time interval between times 1428 and 1638, both crossings of the d₀ 1408 level. The time interval T₇₆ 1642 corresponds to the time interval between times 1430 and 1636, both crossings of the −d₀ 1416 level.

As can be seen in FIG. 12, the oscillator displacement as shown by the displacement curve 1204 experiences an offset that is correlated with input acceleration as indicated by the acceleration curve 1206. Thus, one way to detect shifts of the displacement curve 1404 and thus input acceleration is to compare relative positions of zero-crossing times. For example, a sum of the time intervals T₄₃ 1432 and T₉₄ 1640 represents a period of oscillation as does a sum of the periods T₆₁ 1434 and T₃₆ 1642. In comparing a subset of the period, such as comparing the time interval T₄₃ 1432 with the sum of T₄₃ 1432 and T₉₄ 1640 represents the proportion of time that the oscillator spends at a displacement greater than +d₀ 1408. An increase in this proportion from a reference proportion indicates a greater acceleration in a positive direction than the reference. Likewise, a decrease in this proportion from the reference indicates a greater acceleration in the negative direction. Other time intervals can be used to calculate other proportions and changes in acceleration.

In some examples, integrating portions of the rectangular waveform using the systems and methods described herein can be performed to determine relative positions of zero-crossing times and thus acceleration, rotation and/or velocity. In other examples, displacement of an oscillator can be determined from the time intervals depicted in FIG. 16 using equations 4, 5, and 6.

$$\begin{matrix}d = \frac{2 {d}_{0} cos ( π \frac{{T}_{61}}{{P}_{m 1}} )}{cos ( π \frac{{T}_{61}}{{P}_{m 1}} ) - cos ( π \frac{{T}_{43}}{{P}_{m 2}} )} - {d}_{0} & ( 4 ) \\ {P}_{m 1} = {T}_{61} + {T}_{76} & ( 5 ) \\ {P}_{m 2} = {T}_{43} + {T}_{94} & ( 6 )\end{matrix}$$

Displacement of the oscillator can be converted to an acceleration using Hooke's Law. Displacement of the oscillator can be calculated recursively for each half cycle of the oscillator. Using this information, the displacement of the oscillator can be recorded as a function of time. This allows the calculation of external perturbations with zero drift and lower broadband noise.

FIG. 17 depicts a relationship between capacitance of an inertial sensor (e.g., the inertial sensor 1100) and displacement of a movable element (e.g. movable element 1002). FIG. 17 includes a capacitance curve 1702 that is periodic and substantially sinusoidal. Thus, monotonic motion of the movable element 1002 (FIG. 10) produces a capacitance that changes non-monotonically with displacement. This non-monotonically is a function of the geometric structure of the sensor 1100 and the manner in which the sensor 1100 is excited.

FIG. 18 depicts a relationship between displacement and the first derivative of capacitance with respect to displacement. FIG. 18 includes a dC/dx curve 1802 which is periodic and substantially sinusoidal. The dC/dx curve 1802 is the first derivative of the capacitance curve 1702. As such, the dC/dx curve 1802 crosses zero when the capacitance curve 1702 experiences a local extremum. Capacitive current is proportional to the first derivative of capacitance and thus proportional to, and shares zero-crossings with, the dC/dx curve 1802.

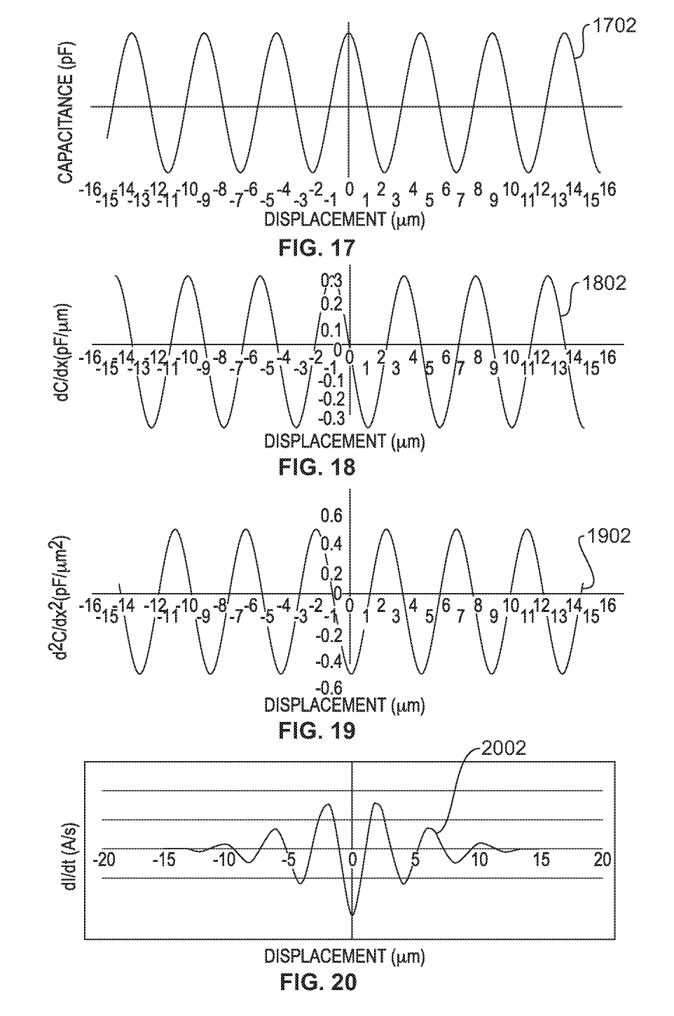

FIG. 19 depicts a relationship between displacement and the second derivative of capacitance with respect to displacement. FIG. 19 includes a d²C/dx² curve 1902. The dC/dx² curve 1902 is the first derivative of the dC/dx curve 1802 and as such has a value of zero at local extrema of the dC/dx curve 1802. The d²C/dx² curve 1902 indicates the slope of the dC/dx curve 1802 and thus indicates locations at which the current is most rapidly changing. In some implementations, it is desirable to maximize the amplitude of the d²C/dx curve 1902 to maximize the steepness of the current curve. This reduces uncertainty in resolving timing of zero-crossings of the current. Reducing uncertainty of the zero-crossing times results in decreased system noise and decreased jitter, as well as, lower gain required of the system. Decreased jitter results in improved resolution of external perturbations. In some implementations, it is desirable to minimize the impact of variable parasitic capacitance, which is parasitic capacitance that varies with oscillator motion.

FIG. 20 depicts a relationship between time, the rate of change of capacitive current, and displacement. FIG. 20 includes a dI/dt curve 2002. The capacitive current used to determine the dI/dt curve 2002 is obtained by applying a fixed voltage across the capacitor used to produce the capacitive curve 1702. The dI/dt curve 2002 represents the rate at which the capacitive current is changing with time and thus provides an indicator of the steepness of the current slope. High magnitudes of the dI/dt signal indicate rapidly changing current and high current slopes. Since the oscillator used to generate the curves shown in FIGS. 17-20 oscillates about zero displacement and reverses direction at displacements of +15 μm and −15 μm, the velocity of the oscillator is lowest at its extrema of displacement. At these displacement extrema, the current is also changing less rapidly and thus the dI/dt curve 2002 has a lower magnitude. Using zero-crossings at which the dI/dt curve 2002 has large values results in improved timing resolution and decreased jitter. These zero-crossings occur near the center of the oscillator's range.

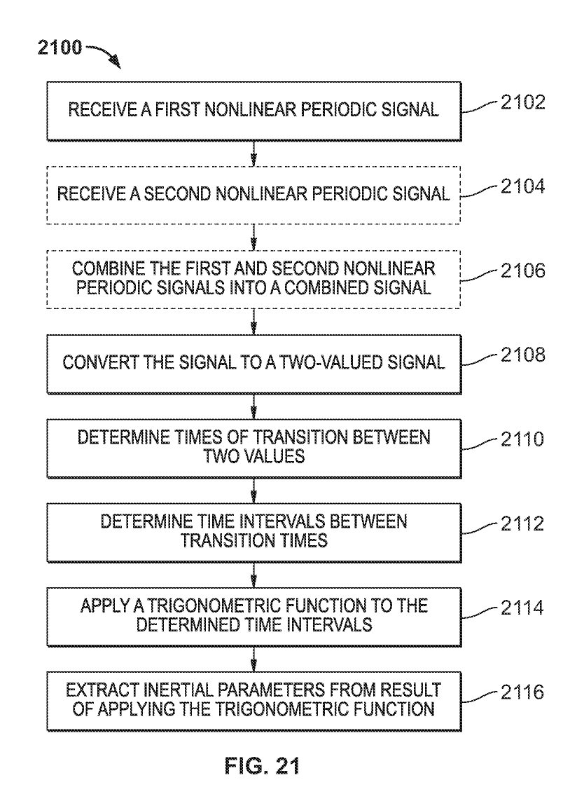

FIG. 21 depicts a flow chart of a method 2100 used to extract inertial parameters from a nonlinear periodic signal. At 2102, a first nonlinear periodic signal is received. At 2104, a second nonlinear periodic signal is optionally received. The first nonlinear periodic signal and the optional second nonlinear periodic signal can be generated by any of the TDS structures depicted in FIGS. 1-9 (e.g., TDS structures 118, 260, 418, 518, 618, 718, 842, 844, and 918) and received at signal processing circuitry configured to extract an inertial parameter from one or more nonlinear periodic signals.

At 2106, optionally, the first and second nonlinear periodic signals are combined into a combined signal. This can be accomplished by the element 1106. If the steps 2104 and 2106 are omitted, the method 2100 proceeds from 2102 directly to 2108.

At 2108, the signal is converted to a two-valued signal by signal processing circuitry that can include a comparator and/or a high-gain amplifier. The two-valued signal can be a signal that has substantially only two values, but may transition quickly between the two values. This two-valued signal can be a digital signal such as that output from a digital circuit element. In some examples, the two-valued signal is produced by amplifying the combined signal or one of the first and second nonlinear signals using a high-gain amplifier. This technique can be referred to as “amplifying to the rails.” The two-valued signal can be the signal 1112. The two-valued signal can be determined based on a threshold such that if the combined, first, or second signal is above the threshold, the two-valued signal takes on a first value and if below the threshold, the two-valued signal takes on a second value.

At 2110, times of transitions between the two values of the two-valued signal are determined. In some examples, these times can be determined using a time-to-digital converter (TDC) or by an analog to digital converter and digital signal processing. The time intervals determined in this way can be one or more of the intervals 1432, 1434, 1640, and 1642.

At 2114, a trigonometric function is applied to the determined time intervals. The trigonometric function can be a sine function, a cosine function, a tangent function, a cotangent function, a secant function, and a cosecant function. The trigonometric function can also be one or more of the inverse trigonometric functions such as the arcsine, the arccosine, the arctangent, the arccotangent, the arcsecant, and the arccosecant functions. Applying the trigonometric function can include applying a trigonometric function to an argument that is based on the determined time intervals.

At 2116, inertial parameters are extracted from the result of applying the trigonometric function. Extracting the inertial parameters can include curve fitting and computing derivatives of the result. The inertial parameters can one or more of sensor acceleration, sensor velocity, sensor displacement, sensor rotation rate, sensor rotational acceleration and higher order derivatives of linear or rotational acceleration, such as jerk, snap, crackle, and pop.

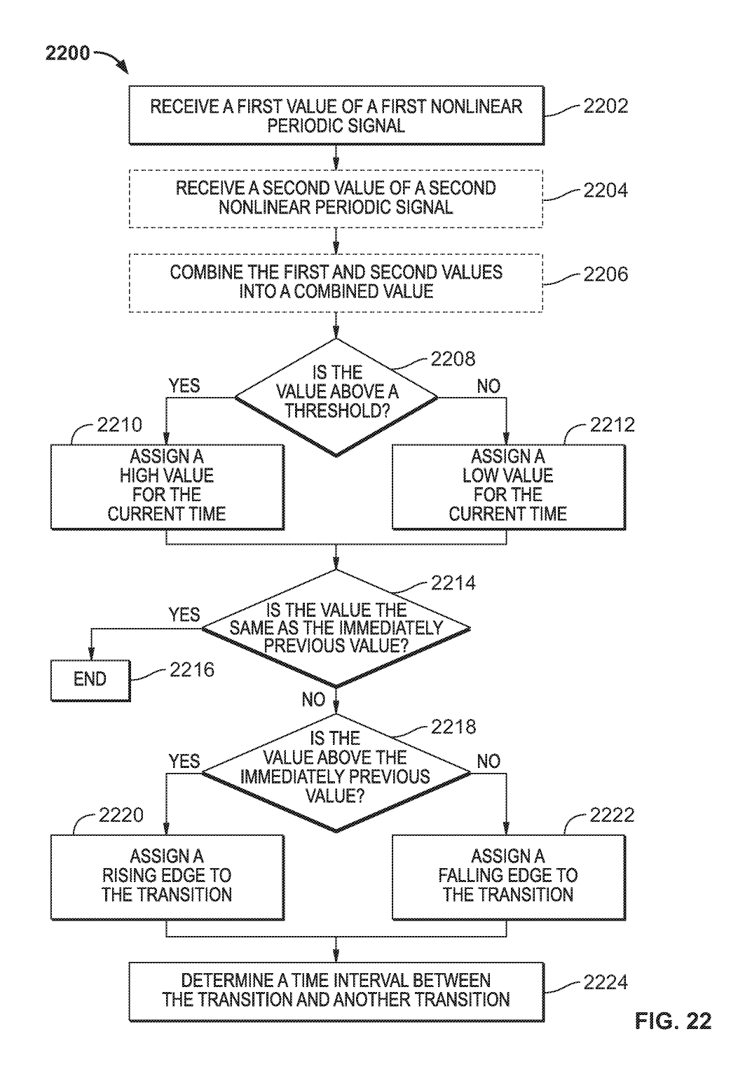

FIG. 22 depicts a method 2200 for determining times of transition between two values based on nonlinear periodic signals. The method 2200 can be used to perform one or more of the steps 2102, 2104, 2106, 2108, and 2110 of the method 2100.

At 2202, a first value of a first nonlinear periodic signal is received at an analog front end, or a block of an ASIC or an FPGA. At 2204, a second value of a second nonlinear periodic signal is optionally received at an analog front end, or a block of an ASIC or an FPGA. The first and second values are values of the first and second signals at particular moments in time, and can be analog or digital values. The first and second nonlinear periodic signals of the method 2200 can be the same as the first and second nonlinear periodic signals of the method 2100.

At 2206, the first and second values are optionally combined into a combined value by a summing circuit or a block of an ASIC or an FPGA. In some examples, the values may be combined using the element 1106 (FIG. 11). Combining may include summing the values, taking a difference of the values, multiplying the values, or dividing the values. If the optional steps 2204 and 2206 are omitted, the method 2200 proceeds from 2202 directly to 2208.

At 2208, the first value or the combined value is compared to a threshold by a comparator or a block of an ASIC or an FPGA. If the value is above the threshold, the method 2200 proceeds to 2210.

At 2210, a high value is assigned for the current time by the comparator or the block of the ASIC or the FPGA used in step 2208. If the value is not above the threshold, the method 2200 proceeds to 2212. At 2212, a low value is assigned for the current time by the comparator or the block of the ASIC or the FPGA used in step 2208. The steps 2208, 2210 and 2212 can be used to generate a two-valued signal having high and low values from an input signal. The two-valued signal of the method 2200 can be the same as the signal of the method 2100.

At 2214, the value of the signal for the current time is compared to a value of the signal for an immediately previous time by a TDC or a block of an ASIC or an FPGA. If the two values are the same, the method 2200 proceeds to 2216 where the method 2200 terminates. If the two values are not the same, a transition has occurred and the method proceeds to 2218.

At 2218, the sense of the transition (whether the transition is a rising edge or a falling edge) is determined by the TDC or the block of the ASIC or the FPGA used in step 2214. If the value for the current time is greater than the value for the previous time, a rising edge is assigned to the transition.

If the value for the current time is not above the value for the previous time, the method 2200 proceeds to 2222. At 2222, a falling edge is assigned to the transition. Thus, times having transitions are detected and classified as having either rising or falling edges. At 2224, a time interval is determined between the transition and another transition by the TDC or the block of the ASIC or the FPGA used in step 2214. Time intervals between these transition times can be determined by obtaining a difference in time values between times of transition.

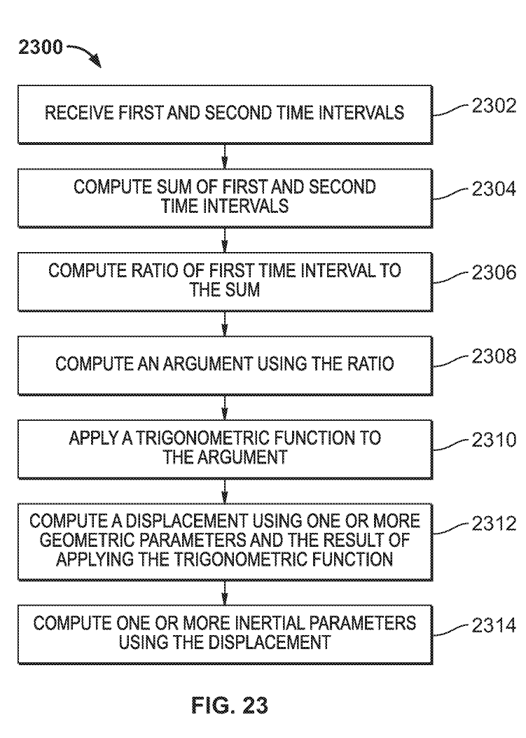

FIG. 23 depicts a method 2300 to compute inertial parameters from time intervals. The method 2300 can be used to perform one or more of the steps 2114 and 2116 of the method 2100.

At 2302, first and second time intervals are received by a block of an ASIC or an FPGA. The first and second time intervals can be determined using the method 2200.

At 2304, a sum of the first and second time intervals is computed by the block of the ASIC or the FPGA used in step 2302. The sum can be the measured period as described by equations 5 and 6. At 2306, a ratio of the first time interval to the sum is computed by the block of the ASIC or the FPGA used in step 2302. The ratio can be one or more of the ratios forming part of the arguments of the cosine functions in equation 4.

At 2308, an argument is computed using the ratio by a block of an ASIC or an FPGA. The argument can be one or more of the arguments of the cosine functions of equation 4.

At 2310, a trigonometric function is applied to the argument by a block of an ASIC or an FPGA. In some examples, the trigonometric function is applied using a lookup table. The trigonometric function can be any of the trigonometric functions described with reference to step 2204 of the method 2100.

At 2312, a displacement is computed by a block of an ASIC or an FPGA using one or more geometric parameters and the result of applying the trigonometric function. The displacement can be computed using equation 4. Computing displacement can involve computing more than one trigonometric function, and arguments other than the computed argument of 2308 can be included as arguments of some of the trigonometric functions.

At 2314, one or more inertial parameters are computed using the displacement by a block of an ASIC or an FPGA. The inertial parameters computed can be any of the inertial parameters described with reference to step 2116 of the method 2100. Inertial parameters can be computed by obtaining one or more derivatives of the displacement with respect to time. Inertial parameters may be extracted using an offset of the computed displacement to determine an external acceleration. In this way, inertial parameters are computed from time intervals.

FIG. 24 depicts a gyroscope subassembly 2400, some or all of the features of which can be included in any of the inertial devices depicted in FIGS. 1-9. The gyroscope subassembly 2400 includes a proof mass 2408 which is coupled to a drive frame 2406 by a system of z-springs 2410. The z-springs 2410 allow the proof mass 2408 to move in the z direction relative to the drive frame 2406. The drive frame 2406 is connected to anchors 2418 and 2420 by drive springs 2412 and 2414, respectively. The drive springs 2412 and 2414 allow the drive frame 2406 to move in the x direction, but prevent the drive frame 2406 from moving in the y direction. The drive frame 2406 is attached to an arm 2404 by a coupling spring 2416. The coupling spring 2416 allows the drive frame 2406 to move in the y direction relative to the arm 2404, but is stiff in the x direction. Because the coupling spring 2416 is stiff in the x direction, it transfers the x component of rotational displacement of the arm 2404 as the arm 2404 rotates about an axis of oscillation. The arm 2404 is connected to a comb drive 2402. The comb drive 2402 includes movable combs connected to the arm 2404. The comb drive 2402 also includes fixed combs adjacent to the movable combs and anchored to a bottom layer (not shown) or a top layer (not shown). The fixed combs are not depicted in FIG. 24 for clarity. The comb drive 2402 causes the arm to rotate about an axis of oscillation. An AC voltage is applied to the comb drive and causes the arm to rotationally oscillate about an axis of oscillation.

The gyroscope subassembly 2400 includes gyroscope electrodes (not shown), such as gyroscope electrodes 426 and 428 described with reference to FIG. 4. The gyroscope electrodes are spaced in the z direction from the proof mass 2408. The gyroscope electrodes detect motion of the proof mass 2408 in the z direction in response to Coriolis forces caused by a rotation of the inertial device containing the gyroscope subassembly 2400. The coupling spring 2416 and the drive springs 2412 and 2414 combine to convert the rotational motion of the arm 2404 into linear motion of the drive frame 2406 along the x axis. Thus, oscillation of the arm 2404 about the z axis causes the proof mass 2408 to oscillate along the x axis.

Signal processing circuitry including an application-specific integrated circuit (ASIC) and/or a field-programmable gate array (FPGA) receives one or more TDS output signals from the TDS structures (e.g., 118, 260, 418, 518, 618, 718, 842, 844, and 918) and receives one or more drive sense output signals from the drive sense combs (e.g., 234, 236, 238, and 240). Based on one or more of the TDS output signals and the drive sense output signals, the signal processing circuitry can then determine acceleration of the inertial device and velocity of a proof mass of the inertial device using the systems and methods described with reference to FIGS. 10-23. The signal processing circuitry can also receive one or more gyroscope output signals of the gyroscope electrodes (e.g., 426 and 428). Based on these gyroscope output signals, the signal processing circuitry can determine the rotation of the inertial device.

The systems described herein can be fabricated using MEMS and microelectronics fabrication processes such as lithography, deposition, and etching. The features of the MEMS structure are patterned with lithography and selected portions are removed through etching. Such etching can include deep reactive ion etching (DRIE) and wet etching. In some examples, one or more intermediate metal, semiconducting, and/or insulating layers are deposited. The base wafer can be a doped semiconductor such as silicon. In some examples, ion implantation can be used to increase doping levels in regions defined by lithography. The spring systems can be defined in a substrate silicon wafer, which is then bonded to top and bottom cap wafers, also made of silicon. Encasing the spring systems in this manner allows the volume surrounding the mass to be evacuated. In some examples, a getter material such as titanium is deposited within the evacuated volume to maintain a low pressure throughout the lifetime of the device. This low pressure enhances the quality factor of the resonator. From the MEMS structure, conducting traces are deposited using metal deposition techniques such as sputtering or physical vapor deposition (PVD). These conducting traces electrically connect active areas of the MEMS structure to microelectronic circuits. Similar conducting traces can be used to electrically connect the microelectronic circuits to each other. The fabricated MEMS and microelectronic structures can be packaged using semiconductor packaging techniques including wire bonding and flip-chip packaging.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, flash memory (e.g., AND/NOR, NAND), memrister memory, and PSRAM.

As used herein, the term “processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, secure microprocessors, and ASICs). Such digital processors may be contained on a single unitary integrated circuit die, or distributed across multiple components.

From the above description of the system it is manifest that various techniques may be used for implementing the concepts of the system without departing from its scope. In some examples, any of the circuits described herein may be implemented as a printed circuit with no moving parts. Further, various features of the system may be implemented as software routines or instructions to be executed on a processing device (e.g. a general purpose processor, an ASIC, an FPGA, etc.) The described embodiments are to be considered in all respects as illustrative and not restrictive. It should also be understood that the system is not limited to the particular examples described herein, but can be implemented in other examples without departing from the scope of the claims.

Similarly, while operations are depicted in the drawings in a particular order, this should not be understood as requiring that such operations be performed in the particular order shown or in sequential order, or that all illustrated operations be performed, to achieve desirable results.

References to axes as x, y, z, u, v, major, and/or minor axes are for the purpose of distinguishing between different axes. A different notation for any given axis, or different axis orientations, can be used without affecting the scope of the disclosure.

The terms first, second, third, fourth, fifth, sixth, seventh, eighth, ninth, etc. are used herein to distinguish between elements, components, etc. These terms when used herein do not imply a sequence or order unless clearly indicated by the context.

1. An inertial device, comprising:
a rotational drive configured to oscillate a plurality of accelerometer proof masses and a plurality of gyroscope proof masses about a z axis, each of the gyroscope proof masses able to deflect in two respective directions that are both orthogonal to a respective oscillation direction; and
signal processing circuitry configured for determining:
based on motion of the plurality of accelerometer proof masses, acceleration of the inertial device along an x axis perpendicular to the z axis and along a y axis perpendicular to each of the x and z axes, and
based on motion of the plurality of gyroscope proof masses in the two respective directions, rotation of the inertial device about each of the x, y, and z axes.

2. The inertial device of claim 1, further comprising coupling springs and drive springs configured for converting rotational motion from the drive into linear motion of each of the plurality of accelerometer proof masses.

3. The inertial device of claim 1, further comprising coupling springs and drive springs configured for converting rotational motion from the drive into linear motion of each of the plurality of gyroscope proof masses.

4. The inertial device of claim 1, further comprising time-domain switched (TDS) structures for determining a drive velocity of one or more of the plurality of gyroscope proof masses.

5. The inertial device of claim 1, wherein the signal processing circuitry is configured for determining acceleration of the inertial device based on one or more offsets in oscillations of one or more of the plurality of accelerometer proof masses.

6. (canceled)

7. The inertial device of claim 1, further comprising a plurality of analog front ends (AFE), each configured for measuring changes in capacitance between one of the plurality of gyroscope proof masses and an electrode adjacent to the respective gyroscope proof mass.

8. The inertial device of claim 7, further comprising a differential amplifier configured for measuring a difference in output between two of the plurality of AFE's, wherein the signal processing circuitry determines rotation of the inertial device based on the difference.

9. The inertial device of claim 1, further comprising suspension springs configured for shifting a resonant frequency of one of the plurality of accelerometer proof masses to a lower frequency than a resonant frequency of one of the plurality of gyroscope proof masses.

10. A method of forming an inertial device, comprising:
forming a plurality of accelerometer proof masses;
forming a plurality of gyroscope proof masses;
forming a rotational drive configured to oscillate the plurality of accelerometer proof masses and the plurality of gyroscope proof masses about a z axis; and
forming coupling springs and drive springs configured for converting rotational motion from the rotational drive into linear motion of the plurality of accelerometer and gyroscope proof masses.

11. The method of claim 10, further comprising forming time-domain switched (TDS) structures configured for determining a drive velocity of one or more of the plurality of gyroscope proof masses.

12. The method of claim 10, further comprising forming TDS structures for determining an acceleration of one or more of the plurality of accelerometer proof masses.

13. The method of claim 10, further comprising forming an electrode adjacent to one or more of the plurality of gyroscope proof masses.

14. The method of claim 10, further comprising forming suspension springs configured for shifting a resonant frequency of one of the plurality of accelerometer proof masses to a lower frequency than a resonant frequency of one of the plurality of gyroscope proof masses.

15. An method of inertial sensing using an inertial device, comprising:
oscillating, with a rotational drive, a plurality of accelerometer proof masses and a plurality of biaxial gyroscope proof masses about a z axis;
determining, based on motion of one or more of the plurality of accelerometer proof masses, acceleration of the inertial device along an x axis perpendicular to the z axis and along a y axis perpendicular to each of the x and z axes; and
determining, based on motion of one or more of the plurality of biaxial gyroscope proof masses in two respective directions that are both orthogonal to respective oscillation directions, rotation of the inertial device about each of the x, y, and z axes.

16. The method of claim 15, further comprising determining, using time-domain switched (TDS) structures, a drive velocity of one or more of the plurality of biaxial gyroscope proof masses.

17. The method of claim 15, further comprising determining acceleration of the inertial device based on one or more offsets in oscillations of one or more of the plurality of accelerometer proof masses.

18. (canceled)

19. The method of claim 15, further comprising measuring, using a plurality of analog front ends (AFE), changes in capacitance between one of the plurality of biaxial gyroscope proof masses and an electrode adjacent to the one of the plurality of biaxial gyroscope proof masses.

20. The method of claim 19, further comprising measuring, using a differential amplifier, a difference in output between two of the plurality of AFE's, wherein determining rotation of the inertial device comprises determining based on the difference.

21. The inertial device of claim 1, wherein, for each of the gyroscope proof masses, a first direction of the two directions is along the z axis and a second direction of the two directions is within a plane defined by the x and y axes.

22. The method of claim 15, wherein, for each of the biaxial gyroscope proof masses, a first direction of the two directions is along the z axis and a second direction of the two directions is within a plane defined by the x and y axes.
